(19) United States
(12) Patent Application Publication
(10) Pub. No.: US 2026/0257403 A1
(43) Pub. Date: Sep. 3, 2026

(54) MOLDED BODY AND CURABLE COMPOSITION

(71) Applicant: CANON KABUSHIKI KAISHA, Tokyo (JP)

(72) Inventors: MASAO SUZUKI, Kanagawa (JP); KEI INOUE, Kanagawa (JP); WAKA HASEGAWA, Tokyo (JP); ICHIRO KANNO, Chiba (JP); MARI KABURAGI, Tokyo (JP); JUNICHI TAMURA, Ibaraki (JP); YUKIHIRO ABE, Chiba (JP); HAYATO IDA, Ibaraki (JP)

(21) Appl. No.: 19/657,517

(22) Filed: Apr. 24, 2026

Related U.S. Application Data
(63) Continuation of application No. PCT/JP2024/038120, filed on Oct. 25, 2024.

(30) Foreign Application Priority Data
Oct. 27, 2023 (JP) 2023-184804
Oct. 17, 2024 (JP) 2024-181876

(51) Int. Cl. B29C 39/00; B29C 39/14; B29C 71/04; B29K 33/00; B29K 105/16; B29K 483/00; B29K 505/02; B29K 505/08; B29K 509/08; G03G 15/00; G03G 15/02; G03G 15/08; G03G 15/16; G03G 15/20

(52) U.S. Cl. CPC B29C 39/003; B29C 39/14; B29C 71/04; B29K 2033/08; B29K 2105/16; B29K 2483/00; B29K 2505/02; B29K 2505/08; B29K 2509/08; B29K 2995/0094; G03G 15/0233; G03G 15/0818; G03G 15/162; G03G 15/2057; G03G 15/206; G03G 15/751

(57) ABSTRACT

Particles are dispersed in a matrix resin to form a molded body. The particles each include a base containing, as a main component, an organosilicon compound having a siloxane bond, and fine particles partly embedded in the base and partly projecting from a surface of the base. The fine particles contain, as a main component, any one of silica, alumina, and titania and form protrusions on the surface of the base.

### CROSS-REFERENCE TO RELATED APPLICATIONS

This application is a Continuation of International Patent Application No. PCT/JP2024/038120, filed Oct. 25, 2024, which claims the benefit of Japanese Patent Application No. 2023-184804 filed Oct. 27, 2023, and Japanese Patent Application No. 2024-181876 filed Oct. 17, 2024, both of which are hereby incorporated by reference herein in their entirety.

### BACKGROUND

### Field of the Technology

The present disclosure relates to a molded body suitable as a sliding member and a curable composition suitable as a raw material of the molded body.

### Description of the Related Art

Resin materials are generally excellent in self-lubricating properties, are lightweight, and generate little noise during sliding, and thus are used for sliding members such as bearings, gears, cams, and rollers. To further reduce energy loss and noise and suppress deterioration of members, resin materials that exhibit sliding characteristics with a lower coefficient of friction and higher wear resistance are required.

Japanese Patent Laid-Open No. 2011-057785 discloses that a resin molded body is obtained using a resin composition that includes a polycarbonate resin containing irregular fine particles having, on surfaces thereof, a shape formed such that each face of a polyhedron having six or more faces is depressed. Japanese Patent Laid-Open No. 2014-162920 discloses that slidability and wear resistance can be imparted by adding, to a plastic, composite particles obtained by coating organic resin particles with polyorganosiloxane.

According to studies by the present inventors, the resin composition obtained using fine particles disclosed in Japanese Patent Laid-Open No. 2011-057785 is expected to provide improved sliding characteristics because the fine particles dispersed in the resin composition reduce the area of contact with an opposing member on a sliding surface and also act as a solid lubricant. In addition, the presence of depressions of the polyhedron on the surfaces of the fine particles increases the area of contact with a matrix resin constituting the molded body, thus providing an advantage of being less likely to detach from the matrix resin even under high-load sliding conditions. However, there is a problem that since the material surrounding the depressed surfaces is also silicone, protrusions on the surfaces of the fine particles or the whole fine particles may be crushed or deformed as a result of long-term sliding or high-load sliding, thus increasing the area of contact with an opposing member, so that initial sliding characteristics cannot be maintained.

According to studies by the present inventors, the resin material obtained using composite particles as disclosed in Japanese Patent Laid-Open No. 2014-162920 provides improved sliding characteristics because surfaces of the resin particles dispersed in the resin material are coated with silicone, but there is a problem that the initial sliding characteristics cannot be maintained for the same reasons as those for the particles described in Japanese Patent Laid-Open No. 2011-057785 because projections on the surfaces are also formed of silicone. In addition, regarding the particles dispersed in the resin material, the relationship between the hardness of the resin particles inside the particles and the hardness of silicone constituting the projections on the surfaces of the resin particles is not disclosed, and there remains room for improvement.

### SUMMARY

The present disclosure is directed to a technique advantageous in achieving a molded body having good mechanical properties and a curable composition suitable as a raw material of the molded body.

A first molded body according to the present disclosure is a molded body including a matrix resin and a plurality of particles dispersed in the matrix resin,
wherein the particles each include a base containing, as a main component, an organosilicon compound having a siloxane bond, and protrusions supported by the base and disposed on surfaces of the particles,
the protrusions contain an inorganic substance as a main component,
the particles each include the base and fine particles, the base is in a particulate form having recesses in a surface thereof, and the fine particles each have a first portion embedded in each of the recesses of the base and a second portion forming each of the protrusions.

A second molded body according to the present disclosure is a molded body including a matrix resin and a plurality of particles dispersed in the matrix resin,
wherein the particles each include a base containing, as a main component, an organosilicon compound having a siloxane bond, and protrusions supported by the base and disposed on surfaces of the particles,
the protrusions have a Young's modulus higher than a Young's modulus of the base,
the particles each include the base and fine particles, the base is in a particulate form having recesses in a surface thereof, and the fine particles each have a first portion embedded in each of the recesses of the base and a second portion forming each of the protrusions.

A first curable composition according to the present disclosure is a curable composition including a plurality of particles and a curable resin material,
wherein the particles each include a base containing, as a main component, an organosilicon compound having a siloxane bond, and protrusions supported by the base and disposed on surfaces of the particles,
the protrusions contain an inorganic substance as a main component,
the particles each include the base and fine particles, the base is in a particulate form having recesses in a surface thereof, and the fine particles each have a first portion embedded in each of the recesses of the base and a second portion forming each of the protrusions.

A second curable composition according to the present disclosure is a curable composition including a plurality of particles and a curable resin material,
wherein the particles each include a base containing, as a main component, an organosilicon compound having a siloxane bond, and protrusions supported by the base and disposed on surfaces of the particles,
the protrusions have a Young's modulus higher than a Young's modulus of the base,
the particles each include the base and fine particles, the base is in a particulate form having recesses in a surface thereof, and the fine particles each have a first portion embedded in each of the recesses of the base and a second portion forming each of the protrusions.

Features of the present disclosure will become apparent from the following description of embodiments with reference to the attached drawings.

### BRIEF DESCRIPTION OF THE DRAWINGS

FIG. 1A is a schematic diagram for explaining the action of protrusions B of particles.

FIG. 1B is a schematic diagram for explaining the action of the protrusions B of the particles.

FIG. 2 is a schematic diagram for explaining the structure of a particle according to an embodiment.

FIG. 3 illustrates an exemplary configuration of a stereolithography apparatus suitable for producing a molded body.

FIG. 4 is an SEM image of particles No. 3.

FIG. 5 illustrates an exemplary configuration of a machine including a molded body.

### DESCRIPTION OF THE EMBODIMENTS

First, a molded body according to an embodiment will be described, and then a curable composition suitable for producing the molded body will be described. The molded body according to the present embodiment can have good mechanical properties. In particular, the molded body according to the present embodiment can maintain high wear resistance over a long period of time. The molded body according to the present embodiment can have good mechanical properties also from other viewpoints such as strength and elasticity.

### Molded Body

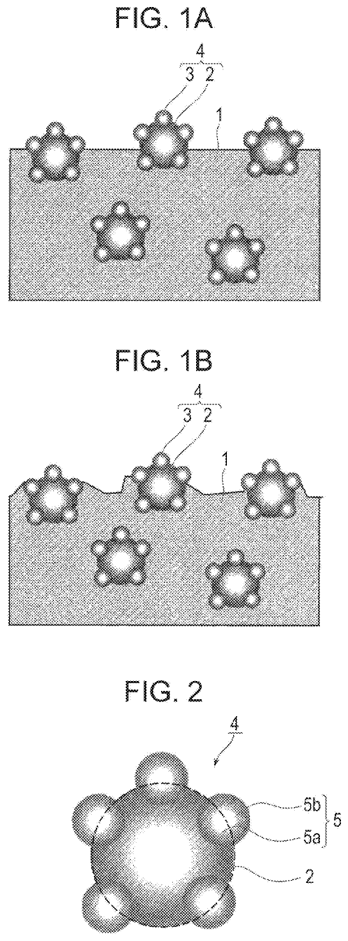

FIG. 1A and FIG. 1B are schematic sectional views of the molded body according to the present embodiment. In the figures, reference numeral 1 denotes a matrix resin, and reference numeral 4 denotes particles. The molded body according to the present embodiment includes the matrix resin 1 and the particles 4, and the particles 4 are dispersed in the matrix resin 1. The particles 4 each include a base A (2) and protrusions B (3). Each of the surface of the base A (2) and the surfaces of the protrusions B (3) is a part of an outer surface of the particles 4, and the surfaces of the protrusions B (3) project, with respect to the surface of the base A (2), outward from the particles 4. Since the particles 4 each include the protrusions B, the particles 4 are non-spherical. Therefore, the particles 4 may be referred to as non-spherical particles. The protrusions B include a material harder than the base A. The main component of the base A (2) is an organic substance, for example, an organosilicon compound (silicone) having an Si—O—Si bond (siloxane bond). The main component of the protrusions B (3) is an inorganic substance, for example, a material harder than silicone. Since the particles 4 are compositely formed of materials having different hardness, the particles 4 may also be referred to as composite particles.

With this configuration, when a load is applied on a sliding surface, the harder protrusions B are not deformed, and the load can be reduced by deformation of the softer base A. Thus, the molded body according to the present embodiment is less likely to undergo a change in the area of contact with an opposing member on the sliding surface, and the particles 4, because of having a large area of contact with the matrix resin 1, are less likely to detach and are less likely to sink into the matrix resin 1. Therefore, it is presumed that the initial wear resistance will be maintained over a long period of time.

FIG. 1A illustrates an initial state of the molded body, and FIG. 1B illustrates a state after use in the case where the molded body is used as a sliding member. As illustrated in FIG. 1A, in the initial state, the particles 4 are partially exposed on the surface of the matrix resin 1. When the molded body is used as a sliding member in this state, the particles 4 on the surface come into contact with an opposing member and are subjected to a load; however, in the particles 4 according to the present embodiment, the protrusions B (3), which have a higher Young's modulus than the base A (2), are not crushed even when subjected to the load and keep projecting on the surfaces of the particles 4. Accordingly, due to such an anchor effect of the protrusions B (3), the particles 4 are less likely to fall off from the matrix resin 1, and a state in which the particles 4 are embedded in the matrix resin 1 is maintained, thus providing excellent sliding characteristics over a long period of time.

Hereinafter, the particles 4 and the matrix resin 1 included in the molded body according to the present embodiment will be described in detail.

### Particles

The particles 4 according to the present embodiment are, for example, particles containing silicone, and include the base A formed of silicone and the protrusions B supported by the base A and disposed on the surfaces of the particles 4. The protrusions B are formed of a material having a Young's modulus higher than that of silicone. In the present embodiment, silicone is composed of at least one silicon compound (silane monomer) represented by any of the following structures (a), (b), and (c). The total content of the structures (a), (b), and (c) in the base A is usually 80 mass % to 100 mass %. The base A may have a core-shell structure, in which case, at least one of a core and a shell, preferably at least the core, and more preferably both the core and the shell are composed of silicone.

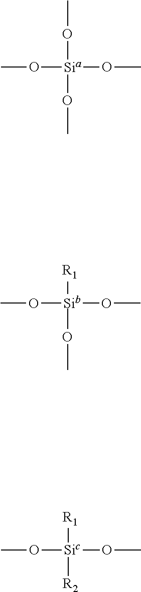

(R₁ and R₂ each represent an alkyl group having 1 to 6 carbon atoms.)

The Young's modulus of the base A is preferably 0.005 GPa or more and 25.000 GPa or less. Although it depends on the Young's modulus of the material constituting the protrusions B, when the Young's modulus of the base A is 0.005 GPa or more and the particles 4 are deformed during stress relaxation, the protrusions B are less likely to sink into the base A, so that the area of contact with an opposing member is kept small, and the specific wear rate can be kept low. When the Young's modulus is 25.000 GPa or less, stress applied from an opposing member is sufficiently relaxed, so that crushing and sinking of the particles 4 into the matrix resin 1 can be suppressed, and the initial sliding characteristics can be maintained over a long period of time. Therefore, if the Young's modulus of the base A is within the above range, when a load is applied on the sliding surface, stress due to the load can be relaxed, and crushing of the particles 4 and sinking of the particles 4 into the matrix resin 1 can be suppressed. The Young's modulus of the base A is more preferably 0.0100 GPa or more and 20.000 GPa or less.

In the present embodiment, the Young's modulus of the base A can be controlled by changing the material composition of the above silane monomers constituting the organosilicon compound, which is the main component of the base A, and the temperature, duration, pH, and type of catalyst in a hydrolysis step and a condensation step. For example, a higher Young's modulus can be achieved by increasing the mixing ratio of the silane monomer having the structure (a), decreasing the mixing ratio of the silane monomer having the structure (b) or (c), increasing the temperature in the hydrolysis step and the condensation step, increasing the time for the hydrolysis step and the condensation step, or increasing the pH in the hydrolysis step and the condensation step. A lower Young's modulus can be achieved by decreasing the mixing ratio of the silane monomer having the structure (a), increasing the mixing ratio of the silane monomer having the structure (b) or (c), adding the silane monomer having the structure (a) after the hydrolysis of the silane monomer having the structure (b) or (c), decreasing the temperatures in the hydrolysis step and the condensation step, decreasing the time for the hydrolysis step and the condensation step, or decreasing the pH in the hydrolysis step and the condensation step.

The method for producing the particles 4 according to the present embodiment is not particularly limited, but it is preferred that the particles 4 be formed through hydrolysis and polycondensation reaction of silane monomers by a sol-gel process.

Specifically, it is preferred that the particles 4, which are composite particles, be formed by subjecting at least one of a tetrafunctional silane monomer having the structure (a), a trifunctional silane monomer having the structure (b), and a difunctional silane monomer having the structure (c) to hydrolysis and polycondensation, and reacting the resultant with fine particles C of any one of silica, titania, and alumina.

The proportion of the silane monomer having the structure (a) is preferably 5 mol % or more and 70 mol % or less, more preferably 20 mol % or more and 65 mol % or less. The proportion of the silane monomer having the structure (b) is preferably 90 mol % or less, more preferably 70 mol % or less. The proportion of the silane monomer having the structure (c) is preferably 5 mol % or more and 90 mol % or less, more preferably 10 mol % or more and 80 mol % or less.

The method for producing the base A is not particularly limited, and for example, the base A can be obtained by adding a silane monomer to water dropwise, and subjecting the silane monomer to hydrolysis and condensation reaction with a catalyst, followed by filtering the resulting suspension, and performing drying. The particle size of the base A can be controlled by the choice of the type of catalyst, the blending ratio, the reaction start temperature, the dropwise addition time, etc. Examples of the catalyst include acidic catalysts such as hydrochloric acid, hydrofluoric acid, sulfuric acid, and nitric acid, and basic catalysts such as aqueous ammonia, sodium hydroxide, and potassium hydroxide, but are not limited thereto.

The particles 4 are preferably produced by the following method. Specifically, the method preferably includes a first step of obtaining a hydrolysate of a silane monomer, a second step of mixing the hydrolysate, an alkaline aqueous medium, and a metal oxide selected from silica, titania, and alumina to allow the hydrolysate to undergo a polycondensation reaction and a reaction with the metal oxide selected from silica, titania, and alumina, and a third step of mixing the polycondensation reaction product with an aqueous solution to form particles. For the addition of silica, titania, or alumina, it may be dispersed in the aqueous solution in advance in the third step, or may be added after the formation of particles.

The particles 4 according to the present embodiment can be subjected to surface treatment as necessary to adjust dispersibility in the matrix resin and a radically polymerizable compound. For the surface treatment, known means such as a disilazane compound and a silane coupling agent can be used.

In the first step, in an aqueous solution obtained by dissolving an acidic or alkaline substance serving as a catalyst in water, a silane monomer and the catalyst are brought into contact with each other by methods such as stirring and mixing. As the catalyst, a known catalyst can be suitably used. Specific examples of the catalyst include acidic catalysts such as acetic acid, hydrochloric acid, hydrofluoric acid, sulfuric acid, and nitric acid, and basic catalysts such as aqueous ammonia, sodium hydroxide, and potassium hydroxide.

The amount of the catalyst used is appropriately adjusted depending on the types of the silane monomer and the catalyst. Preferably, the amount is selected in the range of 1×10⁻³ parts by mass or more and 1 part by mass or less relative to 100 parts by mass of water used in hydrolyzing the silane monomer.

When the amount of the catalyst used is 1×10⁻³ parts by mass or more, the reaction proceeds sufficiently. On the other hand, when the amount of the catalyst used is 1 part by mass or less, the concentration of the catalyst remaining as an impurity in fine particles is low, which facilitates hydrolysis. The amount of water used is preferably 2 mol or more and 15 mol or less relative to 1 mol of the silane monomer. When the amount of water is 2 mol or more, the hydrolysis reaction proceeds sufficiently, and when the amount of water is 15 mol or less, productivity improves.

The reaction temperature is not particularly limited, and the reaction may be performed at room temperature or under heating; however, it is preferable to perform the reaction while maintaining the temperature at 10° C. to 60° C. because a hydrolysate can be obtained in a short time and a partial condensation reaction of the produced hydrolysate can be suppressed. The reaction time is not particularly limited, and may be appropriately selected in consideration of the reactivity of the silane monomer used, the composition of a reaction liquid prepared by mixing the silane monomer, an acid, and water, and productivity.

In the second step of the method for producing the particles 4, the raw material solution obtained in the first step and an alkaline aqueous medium are mixed with each other to allow a particle precursor to undergo a polycondensation reaction. Thus, a polycondensation reaction liquid is obtained. Here, the alkaline aqueous medium is a liquid obtained by mixing an alkaline component and water, and optionally an organic solvent and the like.

The alkaline component used for the alkaline aqueous medium is a component whose aqueous solution exhibits basicity and which acts as a neutralizer for the catalyst used in the first step and also as a catalyst for the polycondensation reaction in the second step. Examples of the alkaline component include alkali metal hydroxides such as lithium hydroxide, sodium hydroxide, and potassium hydroxide; ammonia; and organic amines such as monomethylamine and dimethylamine.

The amount of the alkaline component used is an amount such that the alkaline component neutralizes the acid and effectively acts as the catalyst for the polycondensation reaction, and for example, when ammonia is used as the alkaline component, the amount is usually selected in the range of 0.01 parts by mass or more and 12.5 parts by mass or less relative to 100 parts by mass of a mixture of water and an organic solvent.

In the second step, to prepare the alkaline aqueous medium, an organic solvent may further be used in addition to the alkaline component and water. The organic solvent is not particularly limited as long as it is compatible with water, but an organic solvent that dissolves 10 g or more of water per 100 g under normal temperature and normal pressure is suitable.

Specific examples include alcohols such as methanol, ethanol, n-propanol, 2-propanol, butanol, and diacetone alcohol; polyhydric alcohols such as ethylene glycol, diethylene glycol, propylene glycol, glycerol, trimethylolpropane, and hexanetriol; ethers such as ethylene glycol monoethyl ether, diethyl ether, and tetrahydrofuran; amide compounds such as dimethylformamide, dimethylacetamide, and N-methylpyrrolidone; and acetone.

Among the organic solvents listed above, alcohol solvents such as methanol, ethanol, 2-propanol, and butanol are preferred. Furthermore, from the viewpoint of hydrolysis and dehydration-condensation reaction, it is more preferable to select, as the organic solvent, the same alcohol as an alcohol that is produced as a leaving product.

In the third step, the polycondensation reaction product obtained in the second step is mixed with an aqueous solution to form particles. As the aqueous solution, water (tap water, pure water, or the like) can be suitably used, and components that exhibit compatibility with water, such as a salt, an acid, an alkali, an organic solvent, a surfactant, and a water-soluble polymer, may be further added to the water. The temperature of the polycondensation reaction liquid and the aqueous solution at the time of mixing is not particularly limited, and the range of 5° C. to 70° C. is suitably selected in consideration of their composition, productivity, and the like.

As a method of collecting the particles 4, a known method can be used without particular limitation. Examples include skimming of floating particles and filtration, and filtration is preferred because the operation is simple. The method of filtration is not particularly limited, and a known apparatus such as vacuum filtration, centrifugal filtration, and pressure filtration may be selected. The filter paper, filter, filter cloth, and the like used in filtration are not particularly limited as long as they are industrially available, and may be appropriately selected depending on the apparatus used.

The silane monomer used can be appropriately selected depending on the compatibility with a solvent and a catalyst, hydrolyzability, or the like. Examples of tetrafunctional silane monomers having the structure (a) include tetramethoxysilane, tetraethoxysilane, and tetraisocyanatosilane, among which tetraethoxysilane is preferred.

Examples of trifunctional silane monomers having the structure (b) include methyltrimethoxysilane, methyltriethoxysilane, methyldiethoxymethoxysilane, methylethoxydimethoxysilane, methyltrichlorosilane, methylmethoxydichlorosilane, methylethoxydichlorosilane, methyldimethoxychlorosilane, methylmethoxyethoxychlorosilane, methyldiethoxychlorosilane, methyltriacetoxysilane, methyldiacetoxymethoxysilane, methyldiacetoxyethoxysilane, methylacetoxydimethoxysilane, methylacetoxymethoxyethoxysilane, methylacetoxydiethoxysilane, methyltrihydroxysilane, methylmethoxydihydroxysilane, methylethoxydihydroxysilane, methyldimethoxyhydroxysilane, methylethoxymethoxyhydroxysilane, methyldiethoxyhydroxysilane, ethyltrimethoxysilane, ethyltriethoxysilane, ethyltrichlorosilane, ethyltriacetoxysilane, ethyltrihydroxysilane, propyltrimethoxysilane, propyltriethoxysilane, propyltrichlorosilane, propyltriacetoxysilane, propyltrihydroxysilane, butyltrimethoxysilane, butyltriethoxysilane, butyltrichlorosilane, butyltriacetoxysilane, butyltrihydroxysilane, hexyltrimethoxysilane, hexyltriethoxysilane, hexyltrichlorosilane, hexyltriacetoxysilane, hexyltrihydroxysilane, phenyltrimethoxysilane, phenyltriethoxysilane, phenyltrichlorosilane, phenyltriacetoxysilane, and phenyltrihydroxysilane, among which methyltrimethoxysilane is preferred.

Examples of difunctional silane monomers having the structure (c) include di-tert-butyldichlorosilane, di-tert-butyldimethoxysilane, di-tert-butyldiethoxysilane, dibutyldichlorosilane, dibutyldimethoxysilane, dibutyldiethoxysilane, dichlorodecylmethylsilane, dimethoxydecylmethylsilane, diethoxydecylmethylsilane, dichlorodimethylsilane, dimethoxydimethylsilane, diethoxydimethylsilane, and diethyldimethoxysilane, among which dimethyldimethoxysilane is preferred.

The Young's modulus of the protrusions B formed on the surfaces of the particles 4 according to the present embodiment is higher than the Young's modulus of the base A, as described above. Thus, a load on a sliding surface can be reduced by deformation of the base A without deformation of the protrusions B having a higher Young's modulus. Therefore, the area of contact with an opposing member on the sliding surface is less likely to change, and the initial sliding characteristics can be maintained over a long period of time. The Young's modulus of the protrusions B is preferably 50 GPa or more and 500 GPa or less.

When the Young's modulus of the protrusions B is 50 GPa or more, the area of contact with an opposing member is small, leading to higher wear resistance, and when the Young's modulus is 500 GPa or less, the protrusions B tend to be less likely to detach from the base A.

The shape of the protrusions B is not particularly limited, but for example, the above-described metal oxide in a rod shape or a fiber shape can be used. When the metal oxide is in a fiber shape, mesh-like protrusions B can be formed on the surfaces. When the protrusions B are formed of spherical fine particles (fine particles C) that are partially embedded in the base A with the rest existing so as to project from the surface of the base A, the fine particles C are less likely to detach from the surface of the base A even when a load is applied on the sliding surface, which is more preferred.

Considering a sphere having a radius r and a hemisphere obtained by cutting the sphere at a plane (section) passing through the center of the sphere, the area of the section of the hemisphere is πr², and the area of a hemispherical surface is 2πr². In a case (X) where a section of a hemispherical fine particle C having a radius r is in contact with the base A having a spherical shape, the area of contact between the fine particle C and the base A is πr² corresponding to the area of the section. In contrast, in a case (Y) where half of a spherical fine particle C having a radius r is embedded in the base A and a hemispherical surface of the spherical fine particle C having a radius r is in contact with the base A, the area of contact between the fine particle C and the base A is 2πr² corresponding to the area of the hemispherical surface. Thus, since the area of contact can be larger in the case (Y) than in the case (X), it is understood that embedding the fine particles C in the base A makes the fine particles C less likely to detach from the surface of the base A.

That is, it is preferred that the particles 4 each include the base A and the fine particles C, the base A be in a particulate form having recesses in a surface thereof, the fine particles C each have a first portion that is an embedded portion embedded in each of the recesses and a second portion that is a projecting portion projecting from the base A, and the second portion form each of the protrusions B. Examples of the inorganic substance as the main component of the protrusions include metals (including alloys) and metal compounds such as metal oxides, metal nitrides, metal carbides, and metal borides, and metal compounds, particularly, metal oxides, are preferred. In the present embodiment, a metalloid element can be treated as a metallic element or a non-metallic element. For example, silicon (Si) is a typical metalloid element, and metallic silicon is included in metals, and silicon oxide, silicon nitride, and silicon carbide are included in metal compounds. The fine particles C preferably contain, as a main component, any one of silica, titania, and alumina. Silica is a type of silicon oxide.

FIG. 2 shows a schematic sectional view in a case where the protrusions B of the particles 4 according to the present embodiment are formed of the fine particles C. In FIG. 2, reference numeral 4 denotes a particle, reference numeral 2 denotes the base A, and reference numeral 5 denotes the fine particles C. The fine particles C each have a first portion 5a embedded in the base A (2) and a second portion 5b projecting from the base A (2). The second portion 5b of each fine particle C constitutes each protrusion B. In FIG. 2, a circle including an outer surface of the base A (2) is indicated by a broken line, and a boundary between the first portion 5a and the second portion 5b is represented by a portion of the broken line that passes through the fine particles C (5). The second portion 5b of each fine particle C constitutes the surface of each protrusion B and can constitute a part of the outer surface of the particle 4.

The second portion 5b of each fine particle C may be covered with the same material as the material of the base A (2) (e.g., silicone), and the protrusions B may include the same material as the material of the base A (2). In this case, at least part of the surfaces of the protrusions B may include the same material as the material of the base A (2). This may be a form in which beans constituting protrusions on an outer surface of a salted bean mochi (rice cake) are covered with a thin skin of the mochi. The base A (2) may have a core-shell structure, and in this case, the form can be like a salted bean daifuku (rice cake filled with sweet bean paste).

The fine particles C in the present embodiment are preferably any one of silica fine particles, titania fine particles, and alumina fine particles. From the viewpoint of controlling reactivity with a binder component (the base A), silica fine particles, whose surfaces are easily modified, are more preferred. The silica fine particles used in the present embodiment are particles containing silica (i.e., SiO₂) as a main component, and may be particles produced from a silicon compound such as water glass or an alkoxysilane or may be particles obtained by pulverizing quartz.

Specific examples include silica particles produced by a sol-gel method, precipitated silica particles produced by a precipitation method, aqueous colloidal silica particles, fumed silica particles obtained by a gas-phase method, and fused silica particles. Among these, aqueous colloidal silica particles are preferred from the viewpoints of reactivity with the above-described binder component and dispersion stability. Aqueous colloidal silica particles are commercially available or can be prepared by a known method from various starting materials. Aqueous colloidal silica particles can be prepared from silicic acid derived from an alkali silicate solution having a pH of about 9 to about 11, and silicate anions are subjected to polymerization to generate silica particles having a desired average particle size in the form of an aqueous dispersion.

In the present embodiment, a particle size DF of the plurality of particles 4 dispersed in the matrix resin 1 is preferably 0.02 μm or more and 15.00 μm or less. The particle size DF of the plurality of particles 4 can typically be evaluated by an average value (number-average particle size) of particle sizes of the plurality of particles 4, and can also be evaluated by a median value (median diameter) or a most frequent value (mode diameter). When the particle size DF is 0.02 μm or more, the action as a spacer on an opposing member is favorably exhibited, and the effect of improving wear resistance is easily produced. When the particle size DF is 15.00 μm or less, irregularities formed on the sliding surface due to the particles 4 are kept to a moderate size, and good wear resistance is provided. The particle size DF may be 10.00 μm or more and 15.00 μm or less, 5.00 μm or more and less than 10.00 μm, 1.00 μm or more and less than 5.00 μm, or 0.02 μm or more and less than 1.00 μm. The particle size DF is more preferably 0.04 μm or more and 11.00 μm or less.

The particle size DF of the particles 4 can be increased by lowering the reaction temperature, shortening the reaction time, and increasing the amount of catalyst in the hydrolysis and condensation steps.

In the present embodiment, when the particles 4 are each formed of the base A and the fine particles C, a particle size D_{C} of the fine particles C is preferably 0.01 μm or more and 3.00 μm or less, more preferably 0.02 μm or more and 2.00 μm or less. The particle size D_{C} of the plurality of fine particles C can typically be evaluated by an average value (number-average particle size) of particle sizes of the plurality of fine particles C, and can also be evaluated by a median value (median diameter) or a most frequent value (mode diameter). When the particle size DF is 5.00 μm or more, the particle size D_{C} is preferably 0.50 μm or more. When the particle size D_{C} is less than 1.00 μm, the particle size D_{F} is preferably less than 5.00 μm.

In the present embodiment, when a particle size of the base A is D_{A} and a particle size of the fine particles C is D_{C}, D_{C}/D_{A}, the ratio of D_{C} to D_{A}, is preferably 0.050 or more and 0.650 or less. When this ratio is 0.050 or more, the size of the protrusions B relative to the base A is appropriate, the area of contact between an opposing member and the surface of the base A is kept small, and the particles 4 tend to be less likely to detach. When this ratio is 0.650 or less, a sufficient number of fine particles C can be present on the surface of the base A, which reduces the possibility that the surface of the base A comes into contact with an opposing member when a load is applied on the sliding surface. As a result, good wear resistance is provided.

In the present embodiment, the embedding ratio of the fine particles C defined by formula [1] below is preferably 30% or more and 80% or less.

Embedding ratio (%) of fine particles C=(depth of fine particles C embedded in base A/diameter of fine particles C)×100 [1]

When the embedding ratio of the fine particles C is 30% or more, the fine particles C are less likely to detach when a load is applied on the sliding surface, and when the embedding ratio is 80% or less, the surface of the base A and an opposing member are less likely to come into contact with each other, leading to a low coefficient of friction, which is preferred. The embedding ratio is more preferably 50% or more and 80% or less.

The content of the particles 4 in the molded body according to the present embodiment is preferably 1 part by mass or more and 50 parts by mass or less relative to 100 parts by mass of the matrix resin 1. When the content of the particles 4 is 1 part by mass or more relative to 100 parts by mass of the matrix resin 1, the particles 4 in an amount sufficient for improving sliding characteristics can be present on the sliding surface, and the wear resistance is improved. When the content is 50 parts by mass or less, the molded body is provided with a sufficient Young's modulus and good processability, which is preferred.

### Matrix Resin

The matrix resin 1 constituting the molded body according to the present embodiment is not particularly limited, but preferably has a Young's modulus in the range of 1.0 GPa or more and 5.0 GPa or less. When the Young's modulus of the matrix resin 1 is 1.0 GPa or more, the particles 4 are less likely to sink into the matrix resin 1, and the coefficient of friction is less likely to increase even during long-term sliding. When the Young's modulus of the matrix resin 1 is 5.0 GPa or less, deformation of the particles 4 is less likely to occur, and the wear resistance is less likely to deteriorate even during long-term sliding. Therefore, when the Young's modulus is within this range, a molded body that does not undergo a change in sliding characteristics even during long-term sliding and is suitable as a sliding member can be obtained.

In the present embodiment, the Young's modulus of the matrix resin 1 refers to a tensile modulus determined by a tensile test method in accordance with JIS K 7161-1 or ISO 527-1, as described later.

The matrix resin 1 according to the present embodiment includes at least one of a thermoplastic resin, a thermosetting resin, and a photocurable resin. Among thermoplastic resins, a resin selected from the group consisting of polyvinyl resins, polyester resins, polyamide resins, and polyacetal resins is more preferred. Among thermosetting resins or photocurable resins, a resin selected from acrylic resins and epoxy resins is preferred. The matrix resin 1 may be a copolymer, or may be a compatible blend, a mixture, or a dispersion of a plurality of types of resins.

Examples of polyvinyl resins that can be used include polyethylene resins, polypropylene resins, polystyrene resins, polyvinyl chloride resins, polybutadiene resins, polymethyl methacrylate resins, copolymers thereof, and polymer alloys obtained by blending them.

Examples of polyester resins that can be used include polyethylene terephthalate resins, polybutylene terephthalate resins, polybutylene-2,6-naphthalate resins, polytrimethylene terephthalate resins, copolymers thereof, and polymer alloys obtained by blending them.

Examples of polyamide resins that can be used include nylon 6, nylon 11, nylon 12, nylon 66, nylon 610, nylon 612, copolymers thereof, and polymer alloys obtained by blending them.

Examples of polyacetal resins that can be used include polyacetal homopolymers and polyacetal copolymers.

### Method for Producing Molded Body

The molded body according to the present embodiment can be formed by curing a liquid curable composition including the above-described particles 4. Although photocuring is suitable as a method of curing the curable composition, heat curing may also be used, and the matrix resin 1 can be formed by photocuring the curable composition including a photocurable resin material or by heat curing a thermosetting resin material. Alternatively, the matrix resin 1 can be formed by mixing and melt-kneading the above-described particles 4 and a thermoplastic resin material and solidifying the thermoplastic resin material by cooling. Furthermore, the molded body can also be obtained by melting or dissolving a resin composition including the particles 4 that has been once solidified and solidifying the resin composition again. The molded body including the above-described particles 4 can be suitably used as a sliding member.

The shape of the molded body is not particularly limited. The molded body may be shaped as a sliding member, or may be, for example, fiber-shaped or pellet-shaped. The fiber-shaped or pellet-shaped molded body can be used as a raw material and processed into any desired shape using compression molding, transfer molding, laminate molding, injection molding, extrusion molding, blow molding, or the like.

In the molded body according to the present embodiment, the particles 4 are preferably uniformly dispersed in the matrix resin 1.

When a molded body shaped as a sliding member is produced, it can be produced by uniformly dispersing the particles 4 in a liquid curable composition described later and using stereolithography.

When a linear-shaped or pellet-shaped molded body is produced, for example, a method in which the matrix resin 1 and all or some of the particles 4 are simultaneously or separately mixed and homogenized using a mixer such as a blender, a kneader, a roll, or an extruder, or a method in which some of mixed portions are simultaneously or separately mixed using a blender, a kneader, a roll, an extruder, or the like and the remaining components are further mixed and homogenized using such a mixer or an extruder can be employed. Furthermore, a method in which a composition dry-blended in advance is homogenized by melt-kneading in a heated extruder, then extruded into a wire shape, and then cut into a desired length to form granules can also be applied.

The molded body according to the present embodiment can have a volume of 1 mm³ or more, and is preferably applied to a pellet and an injection-molded body having a volume of 1 mm³ or more. The molded body according to the present embodiment can have a volume of 100 mm³ or more, and is preferably applied to an injection-molded body and the like having a volume of 100 mm³ or more. Here, the volume of the molded body refers to the sum of the volume of the continuous matrix resin 1 and the volume of the particles 4 dispersed in the continuous matrix resin 1. A plurality of molded bodies in each of which the sum of the volume of the continuous matrix resin 1 and the volume of the particles 4 dispersed in the continuous matrix resin 1 is less than 1 mm³ are referred to as micro-molded bodies. A large number of micro-molded bodies can be discontinuously disposed on a substrate, and in this case, the volume of each molded body (micro-molded body) is less than 1 mm³.

### Curable Composition

A curable composition including particles in which the ratio of siloxane bonds to Si—O—C bonds is adjusted can be suitably used as a coating for forming a film having excellent sliding characteristics and as a raw material for shaping a sliding member by using stereolithography. A curable composition according to the present embodiment includes the above-described particles 4 and a curable resin material that becomes a matrix resin upon curing. The curable resin material includes a photocurable resin material or a thermosetting resin material. As the photocurable resin material, an acrylic resin material obtained by radical polymerization or an epoxy resin material obtained by cationic polymerization can be used. The curable resin material includes a polymerizable compound and a curing agent. The polymerizable compound is a radically polymerizable compound or a cationically polymerizable compound. The curing agent is a radical polymerization initiator or a cationic polymerization initiator. Hereinafter, an example in which the curable resin material includes a radically polymerizable compound and a curing agent will be described.

### Radically Polymerizable Compound

The radically polymerizable compound is not particularly limited, but if a polyfunctional radically polymerizable compound (A) and a monofunctional radically polymerizable compound (B) are included, a cured product having high toughness can be obtained.

The polyfunctional radically polymerizable compound (A) is a compound having two or more radically polymerizable functional groups in its molecule. Examples of radically polymerizable functional groups include ethylenically unsaturated groups. Examples of ethylenically unsaturated groups include a (meth)acryloyl group and a vinyl group. Examples of polyfunctional radically polymerizable compounds include (meth)acrylate compounds, vinyl ether group-containing (meth)acrylate compounds, (meth)acryloyl group-containing isocyanurate compounds, (meth)acrylamide compounds, urethane (meth)acrylate compounds, maleimide compounds, vinyl ether compounds, and aromatic vinyl compounds. Among them, (meth)acrylate compounds and urethane (meth)acrylate compounds are preferred from the viewpoints of availability and curability.

Various compounds can be used as the polyfunctional radically polymerizable compound (A) in the present embodiment, but a polyfunctional radically polymerizable compound having a urethane structure is particularly preferred in that it is easy to synthesize, is readily available, and provides a shaped article having a high Young's modulus. When the curable composition according to the present embodiment is used as a raw material for stereolithography, a polyfunctional radically polymerizable compound having a polyether structure is preferred in that it has a low viscosity, is smoothly dripped during shaping, and provides a shaped article with high accuracy. A polyfunctional radically polymerizable compound having a polyester structure or a polycarbonate structure is preferred in that it provides a shaped article having a high Young's modulus. The polyfunctional radically polymerizable compound (A) may be a single compound selected from these compounds or may contain two or more thereof. The polyfunctional radically polymerizable compound (A) in the present embodiment is a term collectively referring to one or a plurality of polyfunctional radically polymerizable compounds included in the curable composition.

Examples of the polyfunctional radically polymerizable compound (A) having a urethane structure include compounds obtained by a reaction between a hydroxy group-containing (meth)acrylate compound and a polyvalent isocyanate compound. Other examples include compounds obtained by a reaction between a hydroxy group-containing (meth)acrylate compound, a polyvalent isocyanate compound, and a polyol compound. Compounds obtained by reacting a hydroxy group-containing (meth)acrylate compound, a polyvalent isocyanate compound, and a polyol compound with each other are particularly preferred in that they can achieve a high Young's modulus.

Examples of the hydroxy group-containing (meth)acrylate compound include hydroxyalkyl (meth)acrylates such as 2-hydroxyethyl (meth)acrylate, 2-hydroxypropyl (meth)acrylate, 2-hydroxybutyl(meth)acrylate, 4-hydroxybutyl(meth)acrylate, and 6-hydroxyhexyl (meth)acrylate, 2-hydroxyethyl acryloyl phosphate, 2-(meth)acryloyloxyethyl-2-hydroxypropyl phthalate, caprolactone-modified 2-hydroxyethyl (meth)acrylate, dipropylene glycol (meth)acrylate, fatty acid-modified glycidyl (meth)acrylate, polyethylene glycol mono(meth)acrylate, polypropylene glycol mono (meth)acrylate, 2-hydroxy-3-(meth)acryloyloxypropyl (meth)acrylate, glycerol di (meth)acrylate, 2-hydroxy-3-acryloyl-oxypropyl methacrylate, pentaerythritol tri (meth)acrylate, caprolactone-modified pentaerythritol tri(meth)acrylate, ethylene oxide-modified pentaerythritol tri(meth)acrylate, dipentaerythritol penta(meth)acrylate, caprolactone-modified dipentaerythritol penta(meth)acrylate, and ethylene oxide-modified dipentaerythritol penta(meth)acrylate. These hydroxy group-containing (meth)acrylate compounds may be used alone or in combination of two or more thereof.

Examples of the polyvalent isocyanate compound include aromatic polyisocyanates such as tolylene diisocyanate, diphenylmethane diisocyanate, polyphenylmethane polyisocyanate, modified diphenylmethane diisocyanate, xylylene diisocyanate, tetramethylxylylene diisocyanate, phenylene diisocyanate, and naphthalene diisocyanate, aliphatic polyisocyanates such as pentamethylene diisocyanate, hexamethylene diisocyanate, trimethylhexamethylene diisocyanate, lysine diisocyanate, and lysine triisocyanate, alicyclic polyisocyanates such as hydrogenated diphenylmethane diisocyanate, hydrogenated xylylene diisocyanate, isophorone diisocyanate, norbornene diisocyanate, and 1,3-bis(isocyanatomethyl)cyclohexane, trimer compounds and multimer compounds of these polyisocyanates, allophanate-type polyisocyanates, biuret-type polyisocyanates, and water-dispersible polyisocyanates. These polyvalent isocyanate compounds may be used alone or in combination of two or more thereof.

Examples of the polyol compound include polyether polyols, polyester polyols, polycarbonate polyols, polyolefin polyols, polybutadiene polyols, (meth)acrylic polyols, and polysiloxane polyols. These polyol compounds may be used alone or in combination of two or more thereof.

Examples of polyether polyols include alkylene structure-containing polyether polyols such as polyethylene glycol, polypropylene glycol, polytetramethylene glycol, polybutylene glycol, and polyhexamethylene glycol, and random copolymers and block copolymers of these polyalkylene glycols.

Examples of polyester polyols include polycondensation reaction products of polyhydric alcohols and polycarboxylic acids, ring-opening polymers of cyclic esters (lactones), and reaction products of three components of a polyhydric alcohol, a polycarboxylic acid, and a cyclic ester.

Examples of the polyhydric alcohols include ethylene glycol, diethylene glycol, propylene glycol, dipropylene glycol, trimethylene glycol, 1,4-tetramethylene diol, 1,3-tetramethylene diol, 2-methyl-1,3-trimethylene diol, 1,5-pentamethylene diol, neopentyl glycol, 1,6-hexamethylene diol, 3-methyl-1,5-pentamethylene diol, 2,4-diethyl-1,5-pentamethylene diol, glycerol, trimethylolpropane, trimethylolethane, cyclohexane diols (e.g., 1,4-cyclohexanediol), bisphenols (e.g., bisphenol A), and sugar alcohols (e.g., xylitol and sorbitol).

Examples of the polycarboxylic acids include aliphatic dicarboxylic acids such as malonic acid, maleic acid, fumaric acid, succinic acid, glutaric acid, adipic acid, suberic acid, azelaic acid, sebacic acid, and dodecanedioic acid, alicyclic dicarboxylic acids such as 1,4-cyclohexanedicarboxylic acid, and aromatic dicarboxylic acids such as terephthalic acid, isophthalic acid, orthophthalic acid, 2,6-naphthalenedicarboxylic acid, paraphenylenedicarboxylic acid, and trimellitic acid.

Examples of the cyclic esters include propiolactone, β-methyl-8-valerolactone, and &-caprolactone.

Examples of polycarbonate polyols include reaction products of polyhydric alcohols and phosgene, and ring-opening polymers of cyclic carbonic acid esters (e.g., alkylene carbonates).

Examples of the polyhydric alcohols include the polyhydric alcohols exemplified in the description of the polyester polyols. Examples of the alkylene carbonates include ethylene carbonate, trimethylene carbonate, tetramethylene carbonate, and hexamethylene carbonate.

The polycarbonate polyol may be any compound having a carbonate bond in its molecule and terminated with hydroxyl groups, and may have an ester bond as well as the carbonate bond.

Examples of the polyfunctional radically polymerizable compound (A) having any one of a polyether structure, a polyester structure, and a polycarbonate structure include compounds obtained by reacting any one of the polyether polyols, the polyester polyols, and the polycarbonate polyols described above with a (meth)acrylic acid chloride or a (meth)acrylic acid compound.

The polyfunctional radically polymerizable compound (A) in the present embodiment preferably has an ethylenically unsaturated group equivalent in the range of 700 g/eq or more and 7000 g/eq or less. When the polyfunctional radically polymerizable compound (A) included in the curable composition is a single compound, it is preferable to use a polyfunctional radically polymerizable compound having an ethylenically unsaturated group equivalent of 700 g/eq or more and 7000 g/eq or less. The ethylenically unsaturated group equivalent as used herein is a value obtained by dividing the weight-average molecular weight (Mw) of the polyfunctional radically polymerizable compound by the number of ethylenically unsaturated groups in one molecule. When the curable composition includes a plurality of types of polyfunctional radically polymerizable compounds, the ethylenically unsaturated group equivalent of the polyfunctional radically polymerizable compound (A) can be calculated as an average of ethylenically unsaturated group equivalents of the polyfunctional radically polymerizable compounds, weighted according to their mass ratios in the curable composition. The plurality of types of polyfunctional radically polymerizable compounds are preferably mixed and used at a ratio such that their weighted average is 700 g/eq or more and 7000 g/eq or less. When the curable composition includes a plurality of types of polyfunctional radically polymerizable compounds, the curable composition preferably includes a polyfunctional radically polymerizable compound having an ethylenically unsaturated group equivalent of 700 g/eq or more and 7000 g/eq or less and a polyfunctional radically polymerizable compound having an ethylenically unsaturated group equivalent of less than 700 g/eq.

As the ethylenically unsaturated group equivalent increases, the crosslink density of a cured product after curing decreases, resulting in a cured product having a lower Young's modulus. When the ethylenically unsaturated group equivalent of the polyfunctional radically polymerizable compound (A) is 7000 g/eq or less, the crosslink density of a cured product after curing is equal to or more than a certain level, and the cured product exhibits an appropriate Young's modulus, so that the particles 4 are less likely to sink into the matrix resin 1, and the coefficient of friction tends to be kept low even during long-term sliding. When the ethylenically unsaturated group equivalent is 700 g/eq or more, the crosslink density of a cured product after photocuring is kept within an appropriate range, and the Young's modulus of the cured product falls within an appropriate range, so that deformation of the particles 4 is less likely to occur, and the coefficient of friction tends to be kept low even during long-term sliding.

The weight-average molecular weight (Mw) of the polyfunctional radically polymerizable compound (A) in the present embodiment is a weight-average molecular weight in terms of the molecular weight of standard polystyrene. The weight-average molecular weight can be measured using high-performance liquid chromatography. For example, the measurement can be performed with a Tosoh high-performance GPC apparatus “HLC-8220GPC” to which two Shodex GPCLF-804 columns (exclusion limit molecular weight: 2×10⁶, separation range: 300 to 2×10⁶) are connected in series.

The monofunctional radically polymerizable compound (B) is a compound having one radically polymerizable functional group in its molecule. Adding the monofunctional radically polymerizable compound (B) to the curable composition makes it easy to adjust the range of viscosity. In addition, by adjusting the content of the monofunctional radically polymerizable compound (B) or appropriately selecting the type thereof, the mechanical properties of a cured product obtained by curing the curable composition can be controlled to a desired range.

Examples of the monofunctional radically polymerizable compound (B) include acrylamide compounds, (meth)acrylate compounds, maleimide compounds, styrene compounds, acrylonitrile compounds, vinyl ester compounds, N-vinyl compounds, conjugated diene compounds, vinyl ketone compounds, and vinyl halide/vinylidene halide compounds, but are not limited thereto. Among them, acrylamide compounds, (meth)acrylate compounds, maleimide monomers, and N-vinyl compounds are particularly preferred in that the composition has excellent curability and a shaped article having excellent mechanical properties is provided.

Examples of acrylamide compounds include (meth)acrylamide, N-methyl(meth)acrylamide, N-isopropyl(meth)acrylamide, N-tert-butyl(meth)acrylamide, N-phenyl(meth)acrylamide, N-methylol(meth)acrylamide, N,N-diacetone(meth)acrylamide, N,N-dimethyl(meth)acrylamide, N,N-diethyl(meth)acrylamide, N,N-dipropyl(meth)acrylamide, N,N-dibutyl(meth)acrylamide, N-(meth)acryloylmorpholine, N-(meth)acryloylpiperidine, N-[3-(dimethylamino)propyl]acrylamide, and N-tert-octyl(meth)acrylamide.

Examples of (meth)acrylate compounds include methyl (meth)acrylate, ethyl (meth)acrylate, n-butyl (meth)acrylate, isobutyl (meth)acrylate, tert-butyl (meth)acrylate, 2-ethylhexyl (meth)acrylate, n-octyl (meth)acrylate, i-octyl (meth)acrylate, lauryl (meth)acrylate, stearyl (meth)acrylate, cyclohexyl (meth)acrylate, isobornyl (meth)acrylate, adamantyl (meth)acrylate, 3-hydroxy-1-adamantyl (meth)acrylate, 3,5-dihydroxy-1-adamantyl (meth)acrylate, 2-methyl-2-adamantyl (meth)acrylate, 2-ethyl-2-adamantyl (meth)acrylate, 2-isopropyl-2-adamantyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, 3-methyl-3-oxetanyl-methyl (meth)acrylate, tetrahydrofurfuryl (meth)acrylate, phenyl glycidyl (meth)acrylate, dimethylaminomethyl (meth)acrylate, phenyl cellosolve (meth)acrylate, dicyclopentenyl (meth)acrylate, dicyclopentenyloxyethyl (meth)acrylate, biphenyl (meth)acrylate, 2-hydroxyethyl (meth)acryloyl phosphate, phenyl (meth)acrylate, phenoxyethyl (meth)acrylate, phenoxypropyl (meth)acrylate, benzyl (meth)acrylate, butoxytriethylene glycol (meth)acrylate, 2-ethylhexyl polyethylene glycol (meth)acrylate, nonylphenyl polypropylene glycol (meth)acrylate, methoxydipropylene glycol (meth)acrylate, glycerol (meth)acrylate, trifluoromethyl (meth)acrylate, trifluoroethyl (meth)acrylate, tetrafluoropropyl (meth)acrylate, octafluoropentyl (meth)acrylate, polyethylene glycol (meth)acrylate, polypropylene glycol (meth)acrylate, allyl (meth)acrylate, 2,2,2-trifluoroethyl (meth)acrylate, 2,2,3,3-tetrafluoropropyl (meth)acrylate, 1H,1H,5H,oxtafluoropentyl (meth)acrylate, epichlorohydrin-modified butyl (meth)acrylate, epichlorohydrin-modified phenoxy (meth)acrylate, ethylene oxide (EO)-modified phthalic acid (meth)acrylate, EO-modified succinic acid (meth)acrylate, caprolactone-modified 2-hydroxyethyl (meth)acrylate, N,N-dimethylaminoethyl (meth)acrylate, N,N-diethylaminoethyl (meth)acrylate, morpholino (meth)acrylate, EO-modified phosphoric acid (meth)acrylate, allyloxy methyl acrylate (product name: AO-MA, manufactured by Nippon Shokubai Co., Ltd.), (meth)acrylates having an imide group (product name: M-140, manufactured by Toagosei Co., Ltd.), and monofunctional (meth)acrylates having a siloxane structure.

Examples of maleimide monomers include maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide.

Examples of N-vinyl compounds include N-vinylpyrrolidone, N-vinylcaprolactam, N-vinylimidazole, N-vinylmorpholine, and N-vinylacetamide.

Examples of other monofunctional radically polymerizable compounds (B) include styrene derivatives such as styrene, vinyltoluene, a-methylstyrene, chlorostyrene, styrenesulfonic acid, and salts thereof, vinyl esters such as vinyl acetate, vinyl propionate, vinyl pivalate, vinyl benzoate, and vinyl cinnamate, and vinyl cyanide compounds such as (meth)acrylonitrile.

These monofunctional radically polymerizable compounds may be used alone or in combination of two or more thereof.

The curable composition according to the present embodiment, when used as a raw material for stereolithography, particularly preferably includes the polyfunctional radically polymerizable compound (A) and the monofunctional radically polymerizable compound (B). In this case, the amount of the polyfunctional radically polymerizable compound (A) contained in the curable composition is preferably 20 parts by mass or more and 75 parts by mass or less relative to a total of 100 parts by mass of the polyfunctional radically polymerizable compound (A) and the monofunctional radically polymerizable compound (B). When the content of the polyfunctional radically polymerizable compound (A) is 20 parts by mass or more, the curable composition exhibits good curability, and a shaped article having a good elastic modulus can be obtained. When the content of the polyfunctional radically polymerizable compound (A) is 75 parts by mass or less, a curable composition having a viscosity suitable for stereolithography can be obtained. The content is more preferably 30 parts by mass or more and 75 parts by mass or less, still more preferably 40 parts by mass or more and 65 parts by mass or less.

### Curing Agent

As a curing agent added to the curable composition according to the present embodiment, a photo-radical polymerization initiator is preferably used, and the photo-radical polymerization initiator and a thermal radical polymerization initiator may be used in combination. When the curable composition contains a thermal radical polymerization initiator, performing heat treatment after shaping by light irradiation can drive the polymerization reaction forward, further enhancing the mechanical properties of a shaped article.

Photo-radical polymerization initiators are mainly classified into intramolecular cleavage-type ones and hydrogen abstraction-type ones. In the case of an intramolecular cleavage-type one, a bond at a specific site is broken upon absorption of light of a specific wavelength, radicals are generated at the broken site, and the radicals serve as a polymerization initiator to initiate polymerization of the polyfunctional radically polymerizable compound (A) and the monofunctional radically polymerizable compound (B). In the case of a hydrogen abstraction-type one, light of a specific wavelength is absorbed to create an excited state, and the excited species causes a reaction of hydrogen abstraction from the surrounding hydrogen donors to generate radicals. The generated radicals serve as a polymerization initiator to initiate polymerization of the polyfunctional radically polymerizable compound (A) and the monofunctional radically polymerizable compound (B). In the present embodiment, two or more types of photo-radical polymerization initiators may be used in combination, or a single photo-radical polymerization initiator may be used.

Known intramolecular cleavage-type photo-radical polymerization initiators include alkylphenone-based photo-radical polymerization initiators, acylphosphine oxide-based photo-radical polymerization initiators, and oxime ester-based photo-radical polymerization initiators. These are of a type in which a bond adjacent to a carbonyl group undergoes a-cleavage to generate radical species.

Examples of alkylphenone-based photo-radical polymerization initiators include benzyl methyl ketal-based photo-radical polymerization initiators, a-hydroxyalkylphenone-based photo-radical polymerization initiators, and aminoalkylphenone-based photo-radical polymerization initiators. For non-limiting examples of specific compounds, examples of benzyl methyl ketal-based photo-radical polymerization initiators include 2,2′-dimethoxy-1,2-diphenylethan-1-one (Irgacure(R) 651, manufactured by BASF); examples of α-hydroxyalkylphenone-based photo-radical polymerization initiators include 2-hydroxy-2-methyl-1-phenylpropan-1-one (Darocur® 1173, manufactured by BASF), 1-hydroxycyclohexyl phenyl ketone (Irgacure® 184, manufactured by BASF), 1-[4-(2-hydroxyethoxy)phenyl]-2-hydroxy-2-methyl-1-propan-1-one (Irgacure® 2959, manufactured by BASF), and 2-hydroxy-1-{4-[4-(2-hydroxy-2-methylpropionyl)benzyl]phenyl}-2-methylpropan-1-one (Irgacure® 127, manufactured by BASF); and examples of aminoalkylphenone-based photo-radical polymerization initiators include 2-methyl-1-(4-methylthiophenyl)-2-morpholinopropan-1-one (Irgacure® 907, manufactured by BASF) and 2-benzylmethyl-2-dimethylamino-1-(4-morpholinophenyl)-1-butanone (Irgacure® 369, manufactured by BASF).

Examples of acylphosphine oxide-based photo-radical polymerization initiators include 2,4,6-trimethylbenzoyldiphenylphosphine oxide (Lucirin(R) TPO, manufactured by BASF) and bis(2,4,6-trimethylbenzoyl)-phenylphosphine oxide (Omnirad(R) 819, manufactured by IGM Resins), but are not limited thereto.

Examples of oxime ester-based photo-radical polymerization initiators include (2E)-2-(benzoyloxyimino)-1-[4-(phenylthio)phenyl]octan-1-one (Irgacure® OXE-01, manufactured by BASF), but are not limited thereto.

Examples of hydrogen abstraction-type photo-radical polymerization initiators include anthraquinone derivatives such as 2-ethyl-9,10-anthraquinone and 2-tert-butyl-9,10-anthraquinone, and thioxanthone derivatives such as isopropylthioxanthone and 2,4-diethylthioxanthone, but are not limited thereto.

The addition amount of the photo-radical polymerization initiator contained in the curable composition is preferably 0.1 parts by mass or more and 15 parts by mass or less, more preferably 0.1 parts by mass or more and 10 parts by mass or less, relative to 100 parts by mass of the radically polymerizable compound. To perform sufficient polymerization, a certain amount of the photo-radical polymerization initiator is required, but to maintain light transmittance and to perform uniform polymerization, the amount of the photo-radical polymerization initiator is preferably kept to an appropriate amount.

The thermal radical polymerization initiator is not particularly limited as long as it generates radicals upon heating, and a conventionally known compound can be used. Preferred examples thereof include azo compounds, peroxides, and persulfates.

Examples of azo compounds include 2,2′-azobisisobutyronitrile, 2,2′-azobis(methyl isobutyrate), 2,2′-azobis-2,4-dimethylvaleronitrile, and 1,1′-azobis(1-acetoxy-1-phenylethane).

Examples of peroxides include benzoyl peroxide, di-tert-butylbenzoyl peroxide, tert-butyl peroxypivalate, and di(4-tert-butylcyclohexyl) peroxydicarbonate.

Examples of persulfates include persulfates such as ammonium persulfate, sodium persulfate, and potassium persulfate.

The addition amount of the thermal radical polymerization initiator is preferably 0.1 parts by mass or more and 15 parts by mass or less, more preferably 0.1 parts by mass or more and 10 parts by mass or less, relative to 100 parts by mass of the radically polymerizable compound. The use of the thermal radical polymerization initiator within the appropriate range increases the molecular weight of a cured product and provides good physical properties.

### Other Additives

The curable composition according to the present embodiment may contain various additives as other optional components as long as the object and effects of the present embodiment are not impaired. Examples of the additives include resins such as epoxy resins, polyurethane, polybutadiene, polychloroprene, polyester, styrene-butadiene block copolymers, polysiloxane, petroleum resins, xylene resins, ketone resins, and cellulose resins, engineering plastics such as polycarbonate, modified polyphenylene ether, polyamide, polyacetal, polyethylene terephthalate, polybutylene terephthalate, polyphenylsulfone, polysulfone, polyarylate, polyetherimide, polyether ether ketone, polyphenylene sulfide, polyethersulfone, polyamideimide, liquid crystal polymers, polytetrafluoroethylene, polychlorotrifluoroethylene, and polyvinylidene fluoride, fluorine-based oligomers, silicone-based oligomers, polysulfide-based oligomers, reactive monomers such as fluorine-containing monomers and siloxane structure-containing monomers, soft metals such as gold, silver, and lead, layered crystal structure substances such as graphite, molybdenum disulfide, tungsten disulfide, boron nitride, graphite fluoride, calcium fluoride, barium fluoride, lithium fluoride, silicon nitride, and molybdenum selenide, polymerization inhibitors such as phenothiazine and 2,6-di-tert-butyl-4-methylphenol, photosensitizers such as benzoin compounds, acetophenone compounds, anthraquinone compounds, thioxanthone compounds, ketal compounds, benzophenone compounds, tertiary amine compounds, and xanthone compounds, polymerization initiation aids, leveling agents, wettability improvers, surfactants, plasticizers, ultraviolet absorbers, silane coupling agents, inorganic fillers, pigments, dyes, antioxidants, flame retardants, thickeners, and antifoaming agents.

### Method for Producing Curable Composition

The curable composition according to the present embodiment is produced by adding, to the particles 4 and the curable resin material, other optional components in appropriate amounts as necessary. Specifically, the curable composition can be produced by charging these components into a stirring vessel and stirring the components usually at 30° C. or more and 120° C. or less, preferably 50° C. or more and 100° C. or less. The stirring time in this case is usually 1 minute or more and 6 hours or less, preferably 10 minutes or more and 2 hours or less. The total amount of the particles 4 and the curable resin material is preferably 25 parts by mass or more and 100 parts by mass or less, more preferably 75 parts by mass or more and 100 parts by mass or less, relative to 100 parts by mass of the curable composition excluding the curing agent. Of 100 parts by mass of the curable composition, parts by mass of the remainder other than the particles 4 and the radically polymerizable compound are accounted for by the curing agent and the other components.

The viscosity of the curable composition according to the present embodiment at 25° C. is preferably 50 mPa·s or more and 30,000 mPa·s or less, more preferably 50 mPa·s or more and 10,000 mPa·s or less.

### Method for Producing Sliding Member Using Curable Composition

The curable composition according to the present embodiment can be cured by irradiation with light. Examples of irradiation light include ultraviolet light and infrared light. In particular, for reasons of easy availability due to versatility and easy energy absorption by the photo-radical polymerization initiator, light having a wavelength of 300 nm or more and 450 nm or less can be preferably used. As a light source that emits light, a laser light source (e.g., an Ar laser or a He-Cd laser), a mercury lamp, a xenon lamp, a halogen lamp, a fluorescent lamp, or the like can be used. Among them, the laser light source is preferably employed because the shaping time can be shortened by raising the energy level, and a high shaping accuracy can be achieved by reducing the irradiation diameter. The irradiation light can be appropriately selected according to the type of radical polymerization initiator contained in the curable composition, and can be used in combination of two or more.

The curable composition according to the present embodiment is suitable as a raw material used in producing a sliding member using stereolithography. Specifically, the curable composition according to the present embodiment is irradiated with a light energy beam depending on slice data generated from three-dimensional shape data of a sliding member to be shaped, and thus is supplied with energy required for curing, whereby a sliding member having a desired shape can be produced.

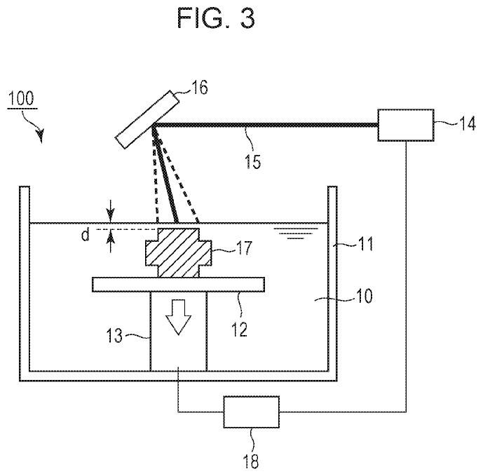

FIG. 3 illustrates an exemplary configuration of a stereolithography apparatus 100 using a free surface method suitable for producing a sliding member. The stereolithography apparatus 100 includes a tank 11 filled with a liquid curable composition 10. The bottom of the tank 11 is formed of a light-transmitting member, and a shaping stage 12 is disposed inside the tank 11 such that the shaping stage 12 can be driven by a drive shaft 13 in the vertical direction. A light beam 15 emitted from a light source 14 can perform scanning while changing its irradiation position depending on the inclination of a galvanometer mirror 16 controlled by a controller 18 according to slice data. In FIG. 3, an example of a scanning range of the light beam 15 is indicated by broken lines.

A thickness d of the curable composition 10 cured by the light energy beam 15 is a value determined based on settings at the time of the generation of the slice data, and affects the accuracy of a three-dimensional object 17 to be obtained (the reproducibility of three-dimensional shape data of an article to be shaped). The thickness d is achieved by the controller 18 controlling the drive amount of the drive shaft 13.

First, the controller 18 controls the drive shaft 13 on the basis of the settings, and the curable composition 10 having a thickness d is supplied onto the shaping stage 12. The liquid curable composition on the shaping stage 12 is selectively irradiated with a light energy beam on the basis of slice data to form a cured layer having a desired pattern. Next, the shaping stage 12 is moved in the direction of the hollow arrow, so that an uncured curable composition having a thickness d is supplied onto the surface of the cured layer. The light energy beam 15 is then applied on the basis of the slice data to form a cured product integrated with the previously formed cured layer. By repeating this step of stacking a cured layer cured to a predetermined thickness d, the three-dimensional object 17 can be obtained.

A molded body 17 obtained in this manner is taken out from the tank 11, the unreacted curable composition remaining on the surface thereof is removed, and then washing and post-processing are performed as necessary. As a washing agent used for washing, alcohol-based organic solvents typified by alcohols such as isopropyl alcohol and ethyl alcohol can be used. In addition, ethyl acetate, ketone-based organic solvents typified by acetone, methyl ethyl ketone, and the like, and aliphatic organic solvents typified by terpenes may be used. After washing with the washing agent, post-processing is performed as necessary. For example, post-curing by light irradiation and/or heat irradiation may be performed. The post-curing can cure the unreacted curable composition remaining on and in the shaped article, can reduce the stickiness of the surface of the shaped article, and can improve the initial strength of the shaped article. As the post-processing, support member removal, surface polishing, and shape processing such as screw hole formation may be performed.

Although FIG. 3 illustrates an example in which the light beam is applied to the curable composition by a point drawing method or a line drawing method to achieve curing, light may be applied by another method. For example, light may be applied in a planar manner through a planar drawing mask formed by arranging a plurality of micro-optical shutters, such as liquid crystal shutters or digital micro-mirror shutters, to cure the curable composition.

Although FIG. 3 illustrates a stereolithography apparatus using a free surface method, the curable composition according to the present embodiment can be used not only in the specific shaping method but also in a constrained surface method.

For the molded body according to the present embodiment, a molded body having a desired shape obtained, for example, from a melt-kneaded material composition by injection molding, extrusion molding, or additive manufacturing such as stereolithography can be used as a member as it is. Alternatively, the obtained molded body can be used after being combined with another molded body by a process such as thermocompression bonding. The molded body according to the present embodiment also includes a film form (coating film) obtained by using a composition including the matrix resin 1 and the particles 4 as a coating liquid, forming a liquid film made of the composition on a surface of a substrate by a method such as dip coating, inkjet coating, or spray coating, and then performing drying and/or curing.

A molded body having good mechanical properties can be used in a machine. A machine in which the molded body according to the present embodiment is used can include the molded body according to the present embodiment, for example, as a mechanical component such as a bearing, a gear, a cam, or a roller. The machine in which the molded body according to the present embodiment is used can realize various equipment. For example, in imaging equipment, the molded body can be used for a mirror drive unit of a single-lens reflex camera; in optical equipment, the molded body can be used for a lens drive unit of an interchangeable lens; and in printing equipment, the molded body can be used for a drive unit of an inkjet apparatus or an electrophotographic apparatus. The molded body can also be applied to industrial equipment such as robots and electronic device manufacturing apparatuses, medical equipment such as CT and MRI apparatuses, and other equipment.

A machine in which a molded body is used as a sliding member includes the molded body as the sliding member and another member, and the molded body and the other member slide against each other. The other member may also be referred to as a member to be slid or an opposing member. In the machine, one of the sliding member and the other member may be movable while the other is fixed, or both may be movable. Due to the presence of the particles 4 on a surface of the molded body, that is, a sliding surface against the other member, good sliding characteristics can be exhibited on the sliding surface.

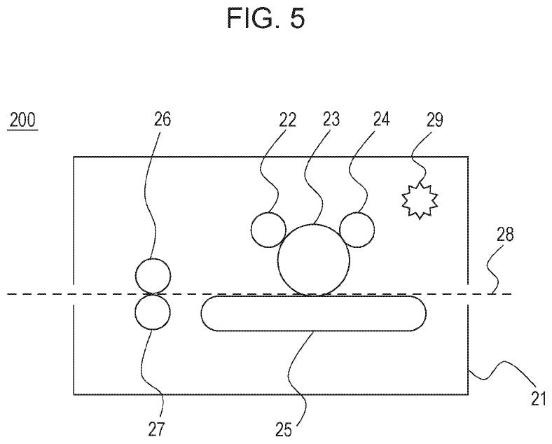

FIG. 5 shows a sectional view of equipment 200, that is, printing equipment including an electrophotographic apparatus. For example, a photosensitive drum 23, various rollers (a charging roller 22, a developing roller 24, a transfer roller, a fixing roller 26, and a pressure roller 27), and various belts (a transfer belt 25 and a fixing belt) included in the electrophotographic apparatus can include the molded body according to the present embodiment. In addition, the equipment 200 can include a housing 21 and other mechanical components 29 such as a bearing, a gear, and a cam. At least one of the drum, the rollers, and the belts includes the molded body according to the present embodiment. For example, a film-shaped molded body can be used as a protective film provided on a surface of at least one of the drum, the rollers, and the belts. At least one of the drum, the rollers, and the belts can slide against other members (the drum, the rollers, or the belts). In the printing equipment illustrated in FIG. 5, a print medium such as paper passes through a path 28. The molded body may be used for a component that slides against the print medium. The electrophotographic apparatus in which the molded body according to the present embodiment is used is expected to operate well over a long period of time.

The molded body according to the present embodiment can maintain good characteristics over a long period of time, and thus is highly durable as a resin member and contributes to the reduction in frequency of component replacement and the extension of product life. Therefore, waste generation can be reduced.

Examples of materials having sliding characteristics include organofluorine compounds such as perfluoroalkyl compounds and polyfluoroalkyl compounds (which are collectively referred to as PFAS), and the molded body and the composition according to the present embodiment can also be used as alternative materials to such organofluorine compounds.

The technology described in the present specification can contribute to realization of a sustainable society such as a decarbonized/circular society. Included configurations

The disclosure according to the present embodiment includes the following configurations.

### Configuration 1

A molded body including a matrix resin and a plurality of particles dispersed in the matrix resin,
wherein the particles each include a base containing, as a main component, an organosilicon compound having a siloxane bond, and protrusions supported by the base and disposed on surfaces of the particles,
the particles each include the base and fine particles, the base is in a particulate form having recesses in a surface thereof, the fine particles each have a first portion embedded in each of the recesses of the base and a second portion forming each of the protrusions, and
the protrusions contain an inorganic substance as a main component.

### Configuration 2

A molded body including a matrix resin and a plurality of particles dispersed in the matrix resin,
wherein the particles each include a base containing, as a main component, an organosilicon compound having a siloxane bond, and protrusions supported by the base and disposed on surfaces of the particles,
the particles each include the base and fine particles, the base is in a particulate form having recesses in a surface thereof, the fine particles each have a first portion embedded in each of the recesses of the base and a second portion forming each of the protrusions, and
the protrusions have a Young's modulus higher than a Young's modulus of the base.

### Configuration 3

The molded body according to configuration 2, wherein the Young's modulus of the base is 0.005 GPa or more and 25.000 GPa or less, and the Young's modulus of the protrusions is 50 GPa or more and 500 GPa or less.

### Configuration 4

The molded body according to any one of configurations 1 to 3, wherein the fine particles contain, as a main component, any one of silica, alumina, and titania.

### Configuration 5

The molded body according to any one of configurations 1 to 4, wherein the plurality of particles have a particle size of 0.02 μm or more and 15.00 μm or less.

### Configuration 6

The molded body according to any one of configurations 1 to 5, wherein, when a particle size of the base is D_{A} and a particle size of the fine particles is D_{C}, D_{C}/D_{A} is 0.050 or more and 0.650 or less.

### Configuration 7

The molded body according to any one of configurations 1 to 6, wherein an embedding ratio of the fine particles defined by formula [1]below is 30% or more and 80% or less.

Embedding ratio (%) of fine particles=(depth of fine particles embedded in base/diameter of fine particles)×100 [1]

### Configuration 8

The molded body according to any one of configurations 1 to 7, wherein the matrix resin has a Young's modulus in a range of 1.0 GPa or more and 5.0 GPa or less.

### Configuration 9

The molded body according to any one of configurations 1 to 8, wherein the matrix resin includes at least one of a polyvinyl resin, a polyester resin, a polyamide resin, a polyacetal resin, an acrylic resin, and an epoxy resin.

### Configuration 10

The molded body according to any one of configurations 1 to 9, wherein the molded body is a film.

### Configuration 11

The molded body according to any one of configurations 1 to 10, wherein a content of the particles is 1 part by mass or more and 50 parts by mass or less relative to 100 parts by mass of the matrix resin.

### Configuration 12

The molded body according to any one of configurations 1 to 11, wherein the molded body has a volume of 1 mm³ or more.

### Configuration 13

The molded body according to any one of configurations 1 to 11, wherein the molded body has a volume of 100 mm³ or more.

### Configuration 14

A curable composition including a plurality of particles and a curable resin material,
wherein the particles each include a base containing, as a main component, an organosilicon compound having a siloxane bond, and protrusions supported by the base and disposed on surfaces of the particles,
the particles each include the base and fine particles, the base is in a particulate form having recesses in a surface thereof, the fine particles each have a first portion embedded in each of the recesses of the base and a second portion forming each of the protrusions, and
the protrusions contain an inorganic substance as a main component.

### Configuration 15

A curable composition including a plurality of particles and a curable resin material,
wherein the particles each include a base containing, as a main component, an organosilicon compound having a siloxane bond, and protrusions supported by the base and disposed on surfaces of the particles,
the particles each include the base and fine particles, the base is in a particulate form having recesses in a surface thereof, the fine particles each have a first portion embedded in each of the recesses of the base and a second portion forming each of the protrusions, and
the protrusions have a Young's modulus higher than a Young's modulus of the base.

### Configuration 16

The curable composition according to configuration 15, wherein the Young's modulus of the base is 0.005 GPa or more and 25.000 GPa or less, and the Young's modulus of the protrusions is 50 GPa or more and 500 GPa or less.

### Configuration 17

The curable composition according to any one of configurations 14 to 16, wherein the fine particles contain, as a main component, any one of silica, alumina, and titania.

### Configuration 18

The curable composition according to any one of configurations 14 to 17, wherein the plurality of particles have a particle size of 0.02 μm or more and 15.00 m or less.

### Configuration 19

The curable composition according to any one of configurations 14 to 18, wherein, when a particle size of the base is D_{A} and a particle size of the fine particles is D_{C}, D_{C}/D_{A} is 0.050 or more and 0.650 or less.

### Configuration 20

The curable composition according to any one of configurations 14 to 19, wherein an embedding ratio of the fine particles defined by formula [1]below is 30% or more and 80% or less.

Embedding ratio (%) of fine particles=(depth of fine particles embedded in base/diameter of fine particles)×100 [1]

### Configuration 21

The curable composition according to any one of configurations 14 to 20, wherein a content of the particles is 1 part by mass or more and 50 parts by mass or less relative to 100 parts by mass of the curable resin material.

### Configuration 22

The curable composition according to any one of configurations 14 to 21, wherein the curable resin material includes a radically polymerizable compound.

### Configuration 23

The curable composition according to any one of configurations 14 to 22, wherein the curable resin material includes a polyfunctional radically polymerizable compound (A) and a monofunctional radically polymerizable compound (B), and the polyfunctional radically polymerizable compound (A) has an ethylenically unsaturated group equivalent of 700 g/eq or more and 7000 g/eq or less.

### Configuration 24

The curable composition according to configuration 23, wherein the polyfunctional radically polymerizable compound (A) is a (meth)acrylate compound or urethane (meth)acrylate compound having any one of a polyether structure, a polyester structure, and a polycarbonate structure.

### Configuration 25

The curable composition according to any one of configurations 14 to 24, wherein the curable resin material includes a photo-radical polymerization initiator.

### Configuration 26

A method for producing a molded body, the method including:
a step of disposing the curable composition according to any one of configurations 14 to 25 so as to have a predetermined thickness; and
a step of irradiating the curable composition having the predetermined thickness with light depending on shape data of a three-dimensional model to cure the curable composition.

### Configuration 27

A machine including the molded body according to any one of configurations 1 to 13 and a member, wherein the molded body and the member are configured to slide against each other.

### Configuration 28

The machine according to configuration 27, wherein the particles are present on a sliding surface of the molded body against the member.

### Configuration 29

A machine including the molded body according to any one of configurations 1 to 13 as a bearing, a gear, a cam, or a roller.

### Configuration 30

An electrophotographic apparatus, wherein at least one of a photosensitive drum, a roller, and a belt includes the molded body according to any one of configurations 1 to 13.

### EXAMPLES

Examples will be given below in order to describe the present embodiment in detail, but the present embodiment is not limited to these examples.

### Methods for Measuring Various Physical Properties

Methods for measuring various physical properties will be described below.

### Separation of Particles Included in Molded Body

Particles included in a molded body can be isolated after a matrix resin forming the molded body is dissolved using a good solvent for the matrix resin. The solvent used is not particularly limited as long as it dissolves the matrix resin and does not dissolve the particles, and for example, when the matrix resin is a polyacetal resin, hexafluoroisopropanol (HFIP) can dissolve only the matrix resin.

When the particles could not be separated by the above method, the molded body was subjected to freezing treatment and then cleaved by a known method, and the following various measurements were performed on particles present on the cleaved surface.

### Method for Acquiring Particle Images

Particle images are acquired using a Hitachi ultra-high resolution field emission scanning electron microscope “5-4800” (Hitachi High-Technologies Corporation).

### (1) Sample Preparation

Conductive paste is thinly applied to a sample stage (aluminum sample stage, 15 mm×6 mm), and particles are sprayed thereon. Furthermore, air blowing is performed to remove excess particles from the sample stage and sufficiently dry the conductive paste. The sample stage is placed in a sample holder, and the height of the sample stage is adjusted to 36 mm using a sample height gauge.

### (2) Setting of S-4800 Observation Conditions

Liquid nitrogen is poured into an anti-contamination trap attached to a housing of S-4800 until it overflows, and left to stand for 30 minutes. “PC-SEM” of S-4800 is started, and flushing (cleaning of an FE tip serving as an electron source) is performed. The acceleration voltage display section of a control panel on the screen is clicked, and the [Flushing] button is pressed to open a flushing execution dialog. After confirming that the flushing intensity is 2, the flushing is executed. The emission current due to the flushing is confirmed to be 20 μA to 40 μA. The sample holder is put into a sample chamber of the S-4800 housing. The [Origin] button on the control panel is pressed to move the sample holder to an observation position.

The acceleration voltage display section is clicked to open an HV setting dialog. The acceleration voltage is set to [1.1 kV], and the emission current to [20 μA]. In the [Basic] tab of an operation panel, the signal selection is set to [SE], [Upper (U)] and [+BSE] are selected for an SE detector, and [L.A. 100] is selected in a selection box at the right of [+BSE], thus setting a mode for observation with a backscattered electron image. In the same [Basic] tab of the operation panel, the probe current in an electron optical system condition block is set to [Normal], the focus mode to [UHR], and WD to [4.5 mm]. The [ON] button in the acceleration voltage display section of the control panel is pressed to apply an acceleration voltage.

### (3) Focus Adjustment

A focus knob [COARSE] on the operation panel is rotated, and after focus is achieved to some extent, the adjustment of aperture alignment is performed. [Align] on the control panel is clicked to display an alignment dialog, and [Beam] is selected. STIGMA/ALIGNMENT knobs (X, Y) on the operation panel are rotated to move a displayed beam to the center of concentric circles. Next, [Aperture] is selected, and the STIGMA/ALIGNMENT knobs (X, Y) are turned one by one to stop or minimize the movement of an image. The aperture dialog is closed, and the focus is adjusted by autofocusing. Thereafter, the magnification is set to 50,000 (50 k), focus adjustment is performed using the focus knob and the STIGMA/ALIGNMENT knobs in the same manner as described above, and the focus is adjusted again by autofocusing. This operation is repeated again to adjust the focus. Here, since the accuracy of coverage measurement tends to be low when the inclination angle of an observation surface is large, an observation surface that entirely comes into focus simultaneously at the time of focus adjustment is selected, whereby a surface having as little inclination as possible is selected and analyzed.

### (4) Image Saving

Brightness is adjusted in ABC mode, and an image is captured at a size of 640×480 pixels and saved. The following analyses are performed using this image file. Images are obtained for at least 25 particles.

### Method for Measuring Particle Size D_{A} of Base A

A particle size D_{A} of a base A is measured from particle images acquired in the above-described manner. First, a Bezier curve is drawn along the contour of a base A of a particle to define the outline of the base A. For a region where the contour is unclear due to the presence of protrusions B or fine particles C on the surface of the base A, the outline is drawn so as to perform interpolation. For the outline of the base A defined in the above manner, a maximum diameter is measured. The number of particles analyzed is 20, and an average value of maximum diameters is determined as D_{A} in the present examples.

Method for Measuring Particle Size D_{C} of Fine Particles C and Calculation of D_{C}/D_{A}

A particle size D_{C} of fine particles C is measured from the particle images acquired in the above-described manner. Assuming the fine particles C to be substantially spherical, the contour of the fine particles C projecting from the base A is fitted with a circle. The diameter of the fitted circle is measured and determined as the diameter of the fine particles C. The number of fine particles C analyzed is 20, and an average value is determined as the value of D_{C} in the present examples. D_{C}/D_{A} is calculated from the above-described particle size D_{A} of the base A and the particle size D_{C} of the fine particles C.

### Method for Measuring Particle Size of Particles in Dispersion Liquid

The particle sizes of particles and fine particles in a dispersion liquid during production were measured by a centrifugal sedimentation method. Specifically, 1 g of a dispersion liquid containing particles or fine particles was sampled and charged into a 25 mL glass vial. To the glass vial, 0.2 g of a 5% aqueous Triton solution and 19.8 g of distilled water were added to prepare a solution.

Next, the tip of a probe of an ultrasonic disperser was immersed in the solution, and ultrasonic dispersion was performed at an output of 20 W for 15 minutes to obtain a dispersion liquid. Subsequently, using this dispersion liquid, the number-average particle size of primary particles was measured using a centrifugal sedimentation particle size distribution analyzer DC24000 manufactured by CPS Instruments. The disk rotation speed was set to 18000 rpm, and the true density was set to 1.3 g/cm³. Before the measurement, the analyzer was calibrated using polyvinyl chloride particles having an average particle size of 0.476 μm.

Method for measuring Young's modulus of matrix resin

The Young's modulus of the matrix resin is a tensile modulus determined by a tensile test method in accordance with JIS K 7161-1 or ISO 527-1.

Method for measuring Young's modulus of base A

The Young's modulus of the base Ais determined from a micro-compression test using a Hysitron PI 85L PicoIndenter (manufactured by BRUKER).

The Young's modulus (MPa) is calculated from the inclination of a profile (load-displacement curve) of a displacement (nm) obtained by measurement and a test force (μN).

### Apparatus·Jig

Base system: Hysitron PI-85L
Measuring indenter: circular flat-end indenter having a diameter of 1 am
SEM used: Thermo Fisher Versa 3D
SEM conditions: −10° tilt, 13 pA at 10 keV

### Measurement Conditions

Measurement mode: displacement control
Maximum displacement: 30 nm
Displacement speed: 1 nm/s
Holding time: 2 seconds
Unloading speed: 5 nm/s
   Analysis method

Hertz analysis is applied to a curve obtained when compressed by 0 nm to 10 nm in the obtained load-displacement curve to calculate the Young's modulus of the base A.

### Sample Preparation

Abase A identical to the base A of particles used in Examples was produced and attached onto a silicon wafer to prepare a sample.

### Method for Measuring Young's Modulus of Fine Particles C or Protrusions B

First, the composition of fine particles C or protrusions B is identified. Measurement is performed using a scanning electron microscope “S-4800” (trade name; manufactured by Hitachi, Ltd.). In images acquired by <Method for acquiring particle images> described above, particles having an image contrast between sites derived from the fine particles C or the protrusions B, both of which are inorganic substances, and a site derived from the base A, which is an organic substance, are distinguished as the particles 4 of the present examples, and particles not having such a contrast are distinguished as particles other than the particles 4 of the present examples. The fine particles C, which are inorganic substances, are observed more brightly. The particles are observed with S-4800, and in a field of view magnified up to 2,000,000 times, the composition of the base A and the composition of the fine particles C or the protrusions B are identified using an energy dispersive X-ray analyzer. After the composition of the fine particles C or the protrusions B is identified, fine particles having the same composition as that of the fine particles C or the protrusions B are prepared, and the same measurement as the above-described measurement of the Young's modulus of the base A is performed to determine the Young's modulus of the fine particles C or the protrusions B.

When the fine particles C are silica, titania, or alumina, the Young's modulus is measured in the same manner as the above-described measurement of the Young's modulus of the base A using, for example, a widely commercially available powder having a particle size of 50 nm or more or a plate-shaped molded body.

### Method for Measuring Embedding Ratio of Fine Particles C

Particles separated from a molded body are sufficiently dispersed in a visible light curable resin (trade name, Aronix LCR series “D-800”; manufactured by Toagosei Co., Ltd.), and then the dispersion is cured by irradiation with short-wavelength light. The obtained cured product is cut out using an ultramicrotome equipped with a diamond knife to prepare a thin slice sample of 250 nm. Next, the cut-out sample is magnified at a magnification of 40000 times to 50000 times using a transmission electron microscope (JEM-2800 manufactured by JEOL Ltd.) (TEM-EDX), and a particle section is observed. From a sectional image, the diameter of the fine particles C and the depth of the fine particles C embedded in the base A are measured. For each particle, five fine particles C are randomly selected, and the embedding ratio of the fine particles C is calculated by formula [1] below. The number of particles analyzed is 20 or more, and an average value is determined as the embedding ratio of the fine particles C.

$$Embedding ratio ( \% ) of fine particles C = ( depth of fine particles C embedded in base A / diameter of fine particles C ) \times 100 \qquad [ 1 ]$$

### Performance Evaluation of Molded Body

Test pieces of molded bodies produced by methods described later were evaluated by the following methods.

### Specific Wear Rate

The measurement of specific wear rate was performed in accordance with JIS K 7218 Method A under the conditions shown below.

Measuring apparatus: friction and wear tester MODEL EMF-III-F manufactured by A&D Company, Limited.
Test environment: 23° C.±2° C., humidity 50% RH±5% RH
Test piece: test piece Y (size 30 mm×30 mm, thickness 4 mm)
Counter material: made of S45C, ring shape, surface roughness about 0.8 μm Ra, contact area 2 cm²
Load: 50 N
Sliding speed: 50 cm/s
Test time: 100 minutes
Sliding distance: 3 km

### Evaluation Criteria

### (1) Specific Wear Rate

The counter material was pressed against a 30 mm×30 mm surface of a test piece Y under the above load and slid at the above sliding speed. After 100 minutes, the sliding was stopped, and a wear mass was measured from the masses of the test piece before and after the sliding. A wear volume was calculated from the measured wear mass and a specific gravity of the test piece. A value obtained by dividing the calculated wear volume by the sliding distance and the load was determined as a specific wear rate (unit: mm³·N⁻¹ Km⁻¹), and this value was used as an index of wear resistance. Evaluation criteria for wear resistance are shown below. A case where the depth of wear exceeded 1.5 mm within 100 minutes after the start of sliding was rated D as a measurement limit. When the evaluation criterion B is satisfied, it is determined that good wear resistance is obtained, and when the evaluation criterion A is satisfied, it is determined that excellent wear resistance is obtained.
A: Less than 0.3 mm³·N⁻¹ Km⁻¹
B: 0.3 mm³·N⁻¹ Km⁻¹ or more and less than 0.5 mm³·N⁻¹ Km⁻¹
C: 0.5 mm³·N⁻¹ Km⁻¹ or more and less than 0.66 mm³·N⁻¹ Km⁻¹
D: 0.66 mm³ N⁻¹ Km⁻¹ or more

### (2) Evaluation of Adhesion of Particles to Matrix Resin

The counter material was pressed against a 30 mm×30 mm surface of a test piece Y under the above load and slid at the above sliding speed for 5 minutes. The sliding surface at this time was cut out so as to be 5 mm×5 mm, and the surface was air-blown to remove large wear debris. Thereafter, according to the same procedure as in the above-described Method for acquiring particle images, electron micrographs of 10 fields of view were acquired at a magnification of 10000 times. The number of particles present in the acquired images was all counted, and the particle number P₅ per unit area was calculated. Furthermore, after sliding was performed for 10 minutes at the above sliding speed, the particle number P₁₅ per unit area was calculated in the same manner, and a change rate ΔP obtained from formula [2] below was used as an index of adhesion. When the evaluation criterion B is satisfied, it is determined that durability with good adhesion between the resin and the particles is obtained, and when the evaluation criterion A is satisfied, it is determined that excellent durability is obtained.

$$Δ P [ \% ] = ( ( {P}_{5} - {P}_{15} ) / {P}_{5} ) \times 100 \qquad [ 2 ]$$

A: Less than 10%
B: 10% or more and less than 30%
C: 30% or more and less than 40%
D: 40% or more

### Aqueous Dispersion Liquid for Forming Protrusions B

For aqueous dispersion liquids of fine particles C for forming protrusions B used in the present examples, the particle size and solid concentration of the fine particles C in the liquids are shown in Table 1. Aqueous colloidal silica dispersion liquids A to F, an aqueous titania dispersion liquid, and an aqueous alumina dispersion liquid were commercial products, and aqueous silicone fine particle dispersion liquids A and B and an aqueous polyester resin fine particle dispersion liquid were produced by methods described later. Among the commercial products, powder products were each adjusted by being dispersed in water so as to have concentrations (mass %) shown in Table 1, and dispersion liquid products were each concentrated with an evaporator so as to have concentrations (mass %) shown in Table 1 or mixed with water to adjust their solid content concentrations.

TABLE 1

| | Material | | | Particle | |
|---|---|---|---|---|---|
| | species of fine | | Product | size | Concentration |
| | particles C | Manufacturer | name | [μm] | [mass %] |
| Aqueous colloidal | Silica | ADMATECHS CO., | SO-C4 | 1.00 | 40 |
| silica dispersion | | LTD. | | | |
| liquid A | | | | | |
| Aqueous colloidal | Silica | ADMATECHS CO., | SO-C6 | 2.00 | 40 |
| silica dispersion | | LTD. | | | |
| liquid B | | | | | |
| Aqueous colloidal | Silica | Nissan Chemical | ST-N40 | 0.02 | 40 |
| silica dispersion | | Corporation | | | |
| liquid C | | | | | |
| Aqueous colloidal | Silica | NIPPON SHOKUBAI | KW-W30 | 0.32 | 40 |
| silica dispersion | | CO., LTD. | | | |
| liquid D | | | | | |
| Aqueous colloidal | Silica | NIPPON SHOKUBAI | KW-W10 | 0.10 | 40 |
| silica dispersion | | CO., LTD. | | | |
| liquid E | | | | | |
| Aqueous colloidal | Silica | ADMATECHS CO., | SO-C5 | 1.50 | 40 |
| silica dispersion | | LTD. | | | |
| liquid F | | | | | |
| Aqueous titania | Titania | Fuji Titanium Industry | Large particle | 1.00 | 30 |
| dispersion liquid | | Co., Ltd. | size titanium | | |
| | | | oxide | | |
| Aqueous alumina | Alumina | Baikowski SA | Baikalox- | 1.00 | 35 |
| dispersion liquid | | | 1.0CR | | |
| Aqueous silicone fine | Silicone | — | — | 1.04 | 30 |
| particle dispersion | | | | | |
| liquid A | | | | | |
| Aqueous silicone fine | Silicone | — | — | 0.03 | 20 |
| particle dispersion | | | | | |
| liquid B | | | | | |
| Aqueous polyester | Polyester | — | — | 1.00 | 25 |
| resin fine particle | resin | | | | |
| dispersion liquid | | | | | |

### Production of Aqueous Silicone Fine Particle Dispersion Liquid A

### Hydrolysis and Polycondensation Step

(1) A 500 mL beaker was charged with 21.6 g of RO water, 120.0 g of methanol, 0.004 g of acetic acid as a catalyst, and 13.0 g of dimethyldimethoxysilane, and stirring was performed at 45° C. for 5 minutes.
(2) To the mixture, 1.0 g of 28% o aqueous ammonia and 14.5 g of tetraethoxysilane were added, and stirring was performed at 30° C. for 3.0 hours to obtain a raw material solution.

### Particle Formation Step

A 1000 mL beaker was charged with 60.0 g of RO water, and while the RO water was stirred at 25° C., the raw material solution obtained in the above [Hydrolysis and polycondensation step] was added dropwise over 5 minutes. Thereafter, the mixed liquid was heated to 60° C., and stirred for 2.0 hours while being kept at 60° C. The mixed liquid was concentrated with an evaporator to obtain an aqueous silicone fine particle dispersion liquid A for forming protrusions B having a solid content concentration of 30 mass %. The silicone fine particles had a particle size of 1.04 μm.

### Production of Aqueous Silicone Fine Particle Dispersion Liquid B

### Hydrolysis and Polycondensation Step

(1) A 500 mL beaker was charged with 21.6 g of RO water, 120.0 g of methanol, 0.004 g of acetic acid as a catalyst, and 9.5 g of dimethyldimethoxysilane, and stirring was performed at 45° C. for 5 minutes.
(2) To the mixture, 1.0 g of 28% aqueous ammonia and 10.5 g of tetraethoxysilane were added, and stirring was performed at 30° C. for 2.5 hours to obtain a raw material solution.

### Particle Formation Step

A 1000 mL beaker was charged with 200.0 g of RO water, and while the RO water was stirred at 25° C., the raw material solution obtained in the above [Hydrolysis and polycondensation step] was added dropwise over 5 minutes. Thereafter, the mixed liquid was heated to 60° C., and stirred for 3.0 hours while being kept at 60° C. The mixed liquid was concentrated with an evaporator to obtain an aqueous silicone fine particle dispersion liquid B for forming protrusions B having a solid content concentration of 20 mass %. The silicone fine particles had a particle size of 0.03 μm.

### Production of Aqueous Polyester Resin Fine Particle Dispersion Liquid Synthesis of Polyester Resin

Polyoxypropylene(2,2)-2,2-bis(4-hydroxyphenyl)propane (50 mol %), terephthalic acid (48 mol %), and trimellitic acid (2 mol %) were charged into a sufficiently heat-dried two-neck flask and mixed. To 100 parts by mass of the mixture, 0.05 parts by mass of dibutyltin oxide was added, and after the temperature was raised while maintaining an inert atmosphere by introducing nitrogen gas into the vessel, a copolycondensation reaction was performed at 150° C. to 230° C. for about 12 hours, after which the pressure was reduced and the temperature was raised to 210° C. to 250° C., and the copolycondensation reaction was further performed for 2 hours to synthesize a polyester resin.

### Preparation of Aqueous Polyester Resin Fine Particle Dispersion Liquid

After 1200 parts by mass of the polyester resin was dissolved in 2400 parts by mass of THF, dimethylaminoethanol (0.5 equivalent relative to the acid value of the polyester resin) was added, and stirring was performed for 10 minutes. Thereafter, while stirring was performed at a rotation speed of 5000 r/min using a homogenizer (manufactured by IKA: ULTRA-TURRAX T50), 3600 parts by mass of ion-exchanged water was added dropwise. The resulting mixture was treated under reduced pressure (50 mmHg) at 50° C. to remove THF, thereby obtaining an aqueous dispersion liquid of polyester resin fine particles (solid content concentration: 25 mass %, particle size: 1.00 μm).

### Production of Particles No. 1

### Hydrolysis and Polycondensation Step

(1) A 500 mL beaker was charged with 21.6 g of RO water, 135.0 g of methanol, 0.004 g of acetic acid as a catalyst, and 12.2 g of dimethyldimethoxysilane, and stirring was performed at 45° C. for 5 minutes.
(2) To the mixture, 2.0 g of 28% aqueous ammonia and 15.0 g of tetraethoxysilane were added, and stirring was performed at 30° C. for 3.0 hours to obtain raw material solution 1.

### Particle Formation Step 1

A 1000 mL beaker was charged with 120.0 g of RO water, and while the RO water was stirred at 25° C., the entire amount of raw material solution 1 obtained in the above [Hydrolysis and polycondensation step] was added dropwise. After completion of the dropwise addition, the mixed liquid was heated to 60° C., and stirred for 2.0 hours while being kept at 60° C., thereby obtaining a seed particle dispersion liquid having a particle size of 0.12 μm.

### Particle Formation Step 2

A reaction vessel different from that used in the above [Particle formation step 1] was charged with 43.2 parts by mass of RO water and 0.008 parts by mass of acetic acid as a catalyst, and stirring was performed at 40° C. To the mixture, 29.9 parts by mass of tetraethoxysilane and 24.5 parts by mass of dimethyldimethoxysilane were added, and stirring was performed for 1.5 hours. Methanol in an amount of 350 parts by mass and RO water in an amount of 58.8 parts by mass were added to prepare raw material solution 2.

To the seed particle dispersion liquid, raw material solution 2 was added dropwise at 15 mL/hr under stirring at 25° C. The time-dependent change in particle size of particles in the dispersion liquid was measured, and when the particle size reached 2.00 m, 5.0 g of aqueous colloidal silica dispersion liquid A was added, and when the particle size (D_{F}) reached 3.20 μm, the dropwise addition of raw material solution 2 was ended to obtain particles No. 1.

### Production of Particles No. 2

Particles No. 2 were obtained by the same method as particles No. 1, except that in [Particle formation step 2], aqueous colloidal silica dispersion liquid A was not used, 5.0 g of aqueous colloidal silica dispersion liquid B was added when the particle size of particles in the dispersion liquid reached 3.20 μm, and the dropwise addition of raw material solution 2 was ended when the particle size (D_{F}) of particles in the dispersion liquid reached 8.50 μm.

### Production of Particles No. 3

### Hydrolysis and Polycondensation Step

(1) A 500 mL beaker was charged with 21.6 g of RO water, 135.0 g of methanol, 0.004 g of acetic acid as a catalyst, and 12.2 g of dimethyldimethoxysilane, and stirring was performed at 45° C. for 5 minutes.
(2) To the mixture, 2.0 g of 28% aqueous ammonia, 15.0 g of tetraethoxysilane, and 5.0 g of aqueous colloidal silica dispersion liquid C were added, and stirring was performed at 30° C. for 3.0 hours to obtain a raw material solution.

### Particle Formation Step

A 1000 mL beaker was charged with 120.0 g of RO water, and while the RO water was stirred at 25° C., the entire amount of the raw material solution obtained in the above [Hydrolysis and polycondensation step] was added dropwise. After completion of the dropwise addition, the mixed liquid was heated to 60° C., and stirred for 2.0 hours while being kept at 60° C., thereby obtaining particles No. 3 having a particle size (D_{F}) of 0.12 μm.

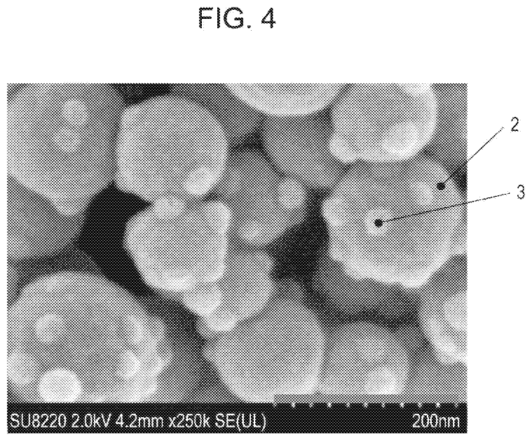

FIG. 4 shows an SEM image of particles No. 3. The scale in FIG. 4 is 200 nm.

### Production of Particles No. 4

Particles No. 4 having a particle size (D_{F}) of 0.04 μm were obtained by the same method as particles No. 3, except that in [Particle formation step], RO water was used in an amount of 200.0 g.

### Production of Particles No. 5

Particles No. 5 were obtained by the same method as particles No. 2, except that in [Particle formation step 2], 5.0 g of aqueous colloidal silica dispersion liquid B was added when the particle size of particles in the dispersion liquid reached 7.0 μm, and the dropwise addition of raw material solution 2 was ended when the particle size (D_{F}) reached 11.0 μm.

### Production of Particles No. 6

Particles No. 6 were obtained by the same method as particles No. 1, except that in [Particle formation step 2], aqueous colloidal silica dispersion liquid B was used instead of aqueous colloidal silica dispersion liquid A.

### Production of Particles No. 7

Particles No. 7 were obtained by the same method as particles No. 6, except that in [Particle formation step 2], aqueous colloidal silica dispersion liquid D was used instead of aqueous colloidal silica dispersion liquid B.

### Production of Particles No. 8

Particles No. 8 having a particle size (D_{F}) of 3.20 μm were obtained by the same method as particles No. 6, except that in [Particle formation step 2], the dropwise addition of raw material solution 2 was ended when the particle size of particles in the dispersion liquid reached 3.10 μm.

### Production of Particles No. 9

Particles No. 9 having a particle size (D_{F}) of 3.20 μm were obtained by the same method as particles No. 6, except that in [Particle formation step 2], aqueous colloidal silica dispersion liquid E was used instead of aqueous colloidal silica dispersion liquid B.

### Production of Particles No. 10

Particles No. 10 having a particle size (D_{F}) of 3.20 μm were obtained by the same method as particles No. 1, except that in [Particle formation step 2], aqueous colloidal silica dispersion liquid A was added when the particle size of particles in the dispersion liquid reached 2.50 μm.

### Production of Particles No. 11

Particles No. 11 having a particle size (D_{F}) of 3.20 μm were obtained by the same method as particles No. 1, except that in [Particle formation step 2], aqueous colloidal silica dispersion liquid A was added when the particle size of particles in the dispersion liquid reached 3.00 μm.

### Production of Particles No. 12

Particles No. 12 having a particle size (D_{F}) of 3.20 μm were obtained by the same method as particles No. 1, except that in [Particle formation step 2], 6.7 g of the aqueous titania dispersion liquid was added instead of aqueous colloidal silica dispersion liquid A.

### Production of Particles No. 13

Particles No. 13 having a particle size (D_{F}) of 3.20 μm were obtained by the same method as particles No. 1, except that in [Particle formation step 2], 5.5 g of the aqueous alumina dispersion liquid was added instead of aqueous colloidal silica dispersion liquid A.

Production of Particles No. 14 Hydrolysis and polycondensation step
(1) A 500 mL beaker was charged with 21.6 g of RO water, 135.0 g of methanol, 0.004 g of acetic acid as a catalyst, and 24.5 g of dimethyldimethoxysilane, and stirring was performed at 45° C. for 5 minutes.
(2) To the mixture, 2.0 g of 28% aqueous ammonia, 1.5 g of tetraethoxysilane, and 1.5 g of trimethoxysilane were added, and stirring was performed at 30° C. for 3.0 hours to obtain raw material solution 1.

### Particle Formation Step 1

A 1000 mL beaker was charged with 120.0 g of RO water, and while the RO water was stirred at 25° C., the entire amount of raw material solution 1 obtained in the above [Hydrolysis and polycondensation step] was added dropwise. After completion of the dropwise addition, the mixed liquid was heated to 60° C., and stirred for 2.0 hours while being kept at 60° C., thereby obtaining a seed particle dispersion liquid having a particle size of 0.31 μm.

### Particle Formation Step 2

A reaction vessel different from that used in the above [Particle formation step 1] was charged with 43.2 parts by mass of RO water and 0.008 parts by mass of acetic acid as a catalyst, and stirring was performed at 40° C. To the mixture, 5.0 parts by mass of tetraethoxysilane, 5.0 parts by mass of trimethoxysilane, and 45.0 parts by mass of dimethyldimethoxysilane were added, and stirring was performed for 1.5 hours. Methanol in an amount of 350 parts by mass and RO water in an amount of 58.8 parts by mass were added to prepare raw material solution 2.

To the seed particle dispersion liquid, raw material solution 2 was added dropwise at 15 mL/hr under stirring at 25° C. The time-dependent change in particle size of particles in the dispersion liquid was measured, and when the particle size reached 2.00 m, 5.0 g of aqueous colloidal silica dispersion liquid F was added, and when the particle size (D_{F}) reached 4.90 μm, the dropwise addition of raw material solution 2 was ended to obtain particles No. 14.

### Production of Particles No. 15

### Hydrolysis and Polycondensation Step

(1) A 500 mL beaker was charged with 21.6 g of RO water, 135.0 g of methanol, 0.004 g of acetic acid as a catalyst, and 8.3 g of dimethyldimethoxysilane, and stirring was performed at 45° C. for 5 minutes.
(2) To the mixture, 2.0 g of 28% aqueous ammonia and 19.2 g of tetraethoxysilane were added, and stirring was performed at 30° C. for 3.0 hours to obtain raw material solution 1.

### Particle Formation Step 1

A 1000 mL beaker was charged with 90.0 g of RO water, and while the RO water was stirred at 25° C., the entire amount of raw material solution 1 obtained in the above [Hydrolysis and polycondensation step] was added dropwise. After completion of the dropwise addition, the mixed liquid was heated to 60° C., and stirred for 2.0 hours while being kept at 60° C., thereby obtaining a seed particle dispersion liquid having a particle size of 0.29 μm.

### Particle Formation Step 2

A reaction vessel different from that used in the above [Particle formation step 1] was charged with 43.2 parts by mass of RO water and 0.008 parts by mass of acetic acid as a catalyst, and stirring was performed at 40° C. To the mixture, 38.1 parts by mass of tetraethoxysilane and 16.3 parts by mass of dimethyldimethoxysilane were added, and stirring was performed for 1.5 hours. Methanol in an amount of 350 parts by mass and RO water in an amount of 58.8 parts by mass were added to prepare raw material solution 2.

To the seed particle dispersion liquid, raw material solution 2 was added dropwise at 15 mL/hr under stirring at 25° C. The time-dependent change in particle size of particles in the dispersion liquid was measured, and when the particle size reached 2.00 m, 5.0 g of aqueous colloidal silica dispersion liquid A was added, and when the particle size (D_{F}) reached 3.20 μm, the dropwise addition of raw material solution 2 was ended to obtain particles No. 15.

### Production of Particles No. 16

### Hydrolysis and Polycondensation Step

(1) A 500 mL beaker was charged with 21.6 g of RO water, 135.0 g of methanol, 0.004 g of acetic acid as a catalyst, and 5.5 g of dimethyldimethoxysilane, and stirring was performed at 45° C. for 5 minutes.
(2) To the mixture, 2.0 g of 28% aqueous ammonia and 22.0 g of tetraethoxysilane were added, and stirring was performed at 30° C. for 3.0 hours to obtain raw material solution 1.

### Particle Formation Step 1

A 1000 mL beaker was charged with 120.0 g of RO water, and while the RO water was stirred at 25° C., the entire amount of raw material solution 1 obtained in the above step of [Hydrolysis and polycondensation step] was added dropwise. After completion of the dropwise addition, the mixed liquid was heated to 60° C., and stirred for 2.0 hours while being kept at 60° C., thereby obtaining a seed particle dispersion liquid having a particle size of 0.12 μm.

### Particle Formation Step 2

A reaction vessel different from that used in the above [Particle formation step 1] was charged with 43.2 parts by mass of RO water and 0.008 parts by mass of acetic acid as a catalyst, and stirring was performed at 40° C. To the mixture, 43.5 parts by mass of tetraethoxysilane and 10.9 parts by mass of dimethyldimethoxysilane were added, and stirring was performed for 1.5 hours. Methanol in an amount of 350 parts by mass and RO water in an amount of 58.8 parts by mass were added to prepare raw material solution 2.

To the seed particle dispersion liquid, raw material solution 2 was added dropwise at 15 mL/hr under stirring at 25° C. The time-dependent change in particle size of particles in the dispersion liquid was measured, and when the particle size reached 2.00 m, 5.0 g of aqueous colloidal silica dispersion liquid A was added, and when the particle size (D_{F}) reached 3.20 μm, the dropwise addition of raw material solution 2 was ended to obtain particles No. 16.

### Production of Particles No. 17

### Hydrolysis and Polycondensation Step

(1) A 500 mL beaker was charged with 21.6 g of RO water, 135.0 g of methanol, 0.004 g of acetic acid as a catalyst, and 5.5 g of dimethyldimethoxysilane, and stirring was performed at 45° C. for 5 minutes.
(2) To the mixture, 2.0 g of 28% aqueous ammonia and 22.0 g of tetraethoxysilane were added, and stirring was performed at 30° C. for 3.0 hours to obtain raw material solution 1.

### Particle Formation Step 1

A 1000 mL beaker was charged with 90.0 g of RO water, and while the RO water was stirred at 25° C., the entire amount of raw material solution 1 obtained in the above [Hydrolysis and polycondensation step] was added dropwise. After completion of the dropwise addition, the mixed liquid was heated to 60° C., and stirred for 2.0 hours while being kept at 60° C., thereby obtaining a seed particle dispersion liquid having a particle size of 0.27 μm.

### Particle Formation Step 2

A reaction vessel different from that used above was charged with 43.2 parts by mass of RO water and 0.008 parts by mass of acetic acid as a catalyst, and stirring was performed at 40° C. To the mixture, 43.5 parts by mass of tetraethoxysilane and 10.9 parts by mass of dimethyldimethoxysilane were added, and stirring was performed for 1.5 hours. Methanol in an amount of 350 parts by mass and RO water in an amount of 58.8 parts by mass were added to prepare raw material solution 2.

To the seed particle dispersion liquid, raw material solution 2 was added dropwise at 15 mL/hr under stirring at 25° C. The time-dependent change in particle size of particles in the dispersion liquid was measured, and when the particle size reached 2.00 m, 25.0 g of aqueous silicone fine particle dispersion liquid A was added, and when the particle size (D_{F}) reached 3.20 μm, the dropwise addition of raw material solution 2 was ended to obtain particles No. 17.

### Production of Particles No. 18

Particles No. 18 having a particle size (D_{F}) of 0.04 μm were obtained by the same method as particles No. 4, except that 5.0 g of aqueous colloidal silica dispersion liquid C was changed to 35.0 g of aqueous silicone fine particle dispersion liquid B.

### Production of Particles No. 19

Particles No. 19 having a particle size (D_{F}) of 3.20 μm were obtained by the same method as particles No. 1, except that 5.0 g of aqueous colloidal silica dispersion liquid A was changed to 8.0 g of the aqueous polyester resin fine particle dispersion liquid.

### Production of Particles No. 20

### Hydrolysis and Polycondensation Step

(1) A 500 mL beaker was charged with 21.6 g of RO water, 135.0 g of methanol, 0.004 g of acetic acid as a catalyst, and 12.2 g of dimethyldimethoxysilane, and stirring was performed at 45° C. for 5 minutes.
(2) To the mixture, 2.0 g of 28% aqueous ammonia and 15.0 g of tetraethoxysilane were added, and stirring was performed at 30° C. for 3.0 hours to obtain raw material solution 1.

### Particle Formation Step 1

A 1000 mL beaker was charged with 120.0 g of RO water, and while the RO water was stirred at 25° C., the entire amount of raw material solution 1 obtained in the above [Hydrolysis and polycondensation step] was added dropwise. After completion of the dropwise addition, the mixed liquid was heated to 60° C., and stirred for 2.0 hours while being kept at 60° C., thereby obtaining a seed particle dispersion liquid having a particle size of 0.12 μm.

### Particle Formation Step 2

A reaction vessel different from that used in the above [Particle formation step 1] was charged with 43.2 parts by mass of RO water and 0.008 parts by mass of acetic acid as a catalyst, and stirring was performed at 40° C. To the mixture, 29.9 parts by mass of tetraethoxysilane and 24.5 parts by mass of dimethyldimethoxysilane were added, and stirring was performed for 1.5 hours. Methanol in an amount of 350 parts by mass and RO water in an amount of 58.8 parts by mass were added to prepare raw material solution 2.

To the seed particle dispersion liquid, raw material solution 2 was added dropwise at 15 mL/hr under stirring at 25° C. The time-dependent change in particle size of particles in the dispersion liquid was measured, and when the particle size (D_{F}) reached 3.20 μm, the dropwise addition of raw material solution 2 was ended to obtain particles No. 20.

Table 2 shows physical property values of particles Nos. 1 to 20 obtained above.

TABLE 2

| | Presence or | | | Young's modulus | | | | | Embedding |
|---|---|---|---|---|---|---|---|---|---|
| | absence of | Fine particles C | | [Gpa] | | Particle size | | Particle | ratio of fine |
| Particles | protrusions | Material | Aqueous dispersion | | Fine | [μm] | | size ratio | particles C |
| No. | B | species | liquid | Base A | particles C | D_{A} | D_{C} | D_{C}/D_{A} | [%] |
| 1 | Present | Silica | Aqueous colloidal silica | 15 | 70 | 3.20 | 1.00 | 0.31 | 65 |
| | | | dispersion liquid A | | | | | | |
| 2 | Present | Silica | Aqueous colloidal silica | 15 | 70 | 8.50 | 2.00 | 0.24 | 65 |
| | | | dispersion liquid B | | | | | | |
| 3 | Present | Silica | Aqueous colloidal silica | 15 | 70 | 0.12 | 0.02 | 0.17 | 65 |
| | | | dispersion liquid C | | | | | | |
| 4 | Present | Silica | Aqueous colloidal silica | 15 | 70 | 0.04 | 0.02 | 0.50 | 65 |
| | | | dispersion liquid C | | | | | | |
| 5 | Present | Silica | Aqueous colloidal silica | 15 | 70 | 11.00 | 2.00 | 0.18 | 65 |
| | | | dispersion liquid B | | | | | | |
| 6 | Present | Silica | Aqueous colloidal silica | 15 | 70 | 3.20 | 2.00 | 0.63 | 65 |
| | | | dispersion liquid B | | | | | | |
| 7 | Present | Silica | Aqueous colloidal silica | 15 | 70 | 3.20 | 0.32 | 0.10 | 65 |
| | | | dispersion liquid D | | | | | | |
| 8 | Present | Silica | Aqueous colloidal silica | 15 | 70 | 3.10 | 2.00 | 0.65 | 65 |
| | | | dispersion liquid B | | | | | | |
| 9 | Present | Silica | Aqueous colloidal silica | 15 | 70 | 3.20 | 0.10 | 0.03 | 65 |
| | | | dispersion liquid E | | | | | | |
| 10 | Present | Silica | Aqueous colloidal silica | 15 | 70 | 3.20 | 1.00 | 0.31 | 40 |
| | | | dispersion liquid A | | | | | | |
| 11 | Present | Silica | Aqueous colloidal silica | 15 | 70 | 3.20 | 1.00 | 0.31 | 20 |
| | | | dispersion liquid A | | | | | | |
| 12 | Present | Titania | Aqueous titania | 15 | 350 | 3.20 | 1.00 | 0.31 | 65 |
| | | | dispersion liquid | | | | | | |
| 13 | Present | Alumina | Aqueous alumina | 15 | 440 | 3.20 | 1.00 | 0.31 | 65 |
| | | | dispersion liquid | | | | | | |
| 14 | Present | Silica | Aqueous colloidal silica | 0.01 | 70 | 4.90 | 1.50 | 0.31 | 65 |
| | | | dispersion liquid F | | | | | | |
| 15 | Present | Silica | Aqueous colloidal silica | 21 | 70 | 3.20 | 1.00 | 0.31 | 65 |
| | | | dispersion liquid A | | | | | | |
| 16 | Present | Silica | Aqueous colloidal silica | 27 | 70 | 3.20 | 1.00 | 0.31 | 65 |
| | | | dispersion liquid A | | | | | | |
| 17 | Present | Silicone | Aqueous silicone fine | 15 | 10 | 3.20 | 1.04 | 0.32 | 65 |
| | | | particle dispersion liquid A | | | | | | |
| 18 | Present | Silicone | Aqueous silicone fine | 15 | 12 | 0.04 | 0.03 | 0.75 | 65 |
| | | | particle dispersion liquid B | | | | | | |
| 19 | Present | Polyester | Aqueous polyester resin | 15 | 11 | 3.20 | 1.00 | 0.31 | 65 |
| | | | fine particle dispersion | | | | | | |
| | | | liquid | | | | | | |
| 20 | Absent | — | None | 15 | — | 3.20 | — | — | — |

### Fabrication of Molded Bodies 1 to 28

### Molded Body 1

To 100 parts by mass of a polyoxymethylene (POM) resin (Duracon M90-44, manufactured by Polyplastics Co., Ltd., Young's modulus: 2.7 GPa), 10 parts by mass of particles No. 1 was added, and they were uniformly mixed using a tumbler stirrer. Thereafter, using a twin-screw extruder (Process 11, manufactured by Thermo Fisher Scientific), kneading was performed at a kneading temperature of 200° C. and 200 rpm to obtain a resin composition of Example 1. The obtained composition was pulverized with a cutter mill, and then molded body 1 as a test piece for evaluation (size 30 mm×30 mm, thickness 4 mm) was molded using an injection molding machine (HAAKE MiniJetPro, manufactured by Thermo Fisher Scientific). The molding conditions were set to a cylinder temperature of 200° C., a mold temperature of 80° C., and an injection pressure of 100 MPa.

### Molded Bodies 2 to 16

Molded bodies 2 to 16 were fabricated by the same method as in Example 1, except that particles No. 1 were changed to particles Nos. 2 to 16 as shown in Table 3.

### Molded Bodies 17 and 18

Molded bodies 17 and 18 were fabricated by the same method as molded body 1, except that the amount of particles No. 1 added was changed from 10 parts by mass to 40 parts by mass and 2 parts by mass, as shown in Table 3.

### Molded Body 19

Molded body 19 was fabricated in the same manner as molded body 1, except that the polyoxymethylene resin was changed to a polybutylene terephthalate (PBT) resin (Novaduran 5010R5, manufactured by Mitsubishi Engineering-Plastics Corporation, Young's modulus: 2.4 GPa), and the kneading temperature and the cylinder temperature during injection molding were set to 240° C.

### Molded Body 20

Molded body 20 was fabricated in the same manner as molded body 1, except that the polyoxymethylene resin was changed to a polypropylene (PP) resin (Novatec PP EG7FTB, manufactured by Japan Polypropylene Corporation, Young's modulus: 1.2 GPa), the kneading temperature and the cylinder temperature during injection molding were both set to 220° C., and the mold temperature was set to 50° C.

### Molded Body 21

Molded body 21 was fabricated in the same manner as molded body 1, except that the polyoxymethylene resin was changed to a polyamide (PA) resin (Ultramid A 3K, manufactured by BASF, Young's modulus: 3.1 GPa), the kneading temperature and the cylinder temperature during injection molding were both set to 280° C., and the mold temperature was set to 60° C.

### Molded Body 22

Molded body 22 was fabricated in the same manner as molded body 1, except that the polyoxymethylene resin was changed to a polyethylene (PE) resin (Suntec HDJ340, manufactured by Asahi Kasei Corporation, Young's modulus: 0.8 GPa), the kneading temperature and the cylinder temperature during injection molding were both set to 200° C., and the mold temperature was set to 40° C.

### Molded Bodies 23 to 26

Molded bodies 23 to 26 were fabricated by the same method as molded body 1, except that particles No. 1 were changed to particles Nos. 17 to 20 as shown in Table 3.

### Molded Body 27

Molded body 27 was fabricated by the same method as molded body 1, except that particles No. 1 were not added.

### Molded Body 28

Molded body 28 was fabricated by the same method as molded body 1, except that the amount of particles No. 1 added was changed from 10 parts by mass to 0.5 parts by mass.

### Evaluation of Molded Bodies 1 to 28

For molded bodies 1 to 28 obtained above, the specific wear rate and the adhesion of particles to matrix resin (change rate AP) were evaluated by the above-described evaluation methods. The results are shown in Table 3.

TABLE 3

| | Particles | | | | Evaluation | | | |
|---|---|---|---|---|---|---|---|---|
| | | Amount | Matrix resin | | Change rate ΔP | | Specific wear rate | |
| Molded | | added | | Young's | Measured | | Measured | |
| body | | [parts by | | modulus | value | | value | |
| No. | No. | mass] | Type | [Gpa] | [%] | Evaluation | [mm³ · N⁻¹ · km⁻¹] | Evaluation |
| 1 | 1 | 10 | POM | 2.7 | 3 | A | 0.11 | A |
| 2 | 2 | 10 | POM | 2.7 | 4 | A | 0.18 | A |
| 3 | 3 | 10 | POM | 2.7 | 5 | A | 0.19 | A |
| 4 | 4 | 10 | POM | 2.7 | 6 | A | 0.31 | B |
| 5 | 5 | 10 | POM | 2.7 | 5 | A | 0.33 | B |
| 6 | 6 | 10 | POM | 2.7 | 8 | A | 0.32 | B |
| 7 | 7 | 10 | POM | 2.7 | 10 | B | 0.16 | A |
| 8 | 8 | 10 | POM | 2.7 | 6 | A | 0.40 | B |
| 9 | 9 | 10 | POM | 2.7 | 16 | B | 0.17 | A |
| 10 | 10 | 10 | POM | 2.7 | 15 | B | 0.12 | A |
| 11 | 11 | 10 | POM | 2.7 | 28 | B | 0.12 | A |
| 12 | 12 | 10 | POM | 2.7 | 8 | A | 0.15 | A |
| 13 | 13 | 10 | POM | 2.7 | 7 | A | 0.13 | A |
| 14 | 14 | 10 | POM | 2.7 | 8 | A | 0.39 | B |
| 15 | 15 | 10 | POM | 2.7 | 7 | A | 0.43 | B |
| 16 | 16 | 10 | POM | 2.7 | 8 | A | 0.47 | B |
| 17 | 1 | 40 | POM | 2.7 | 9 | A | 0.39 | B |
| 18 | 1 | 2 | POM | 2.7 | 6 | A | 0.31 | B |
| 19 | 1 | 10 | PBT | 2.4 | 7 | A | 0.20 | A |
| 20 | 1 | 10 | PP | 1.2 | 8 | A | 0.41 | B |
| 21 | 1 | 10 | PA | 3.1 | 8 | A | 0.39 | B |
| 22 | 1 | 10 | PE | 0.8 | 9 | A | 0.47 | B |
| 23 | 17 | 10 | POM | 2.7 | 32 | C | 0.53 | C |
| 24 | 18 | 10 | POM | 2.7 | 38 | C | 0.61 | C |
| 25 | 19 | 10 | POM | 2.7 | 34 | C | 0.58 | C |
| 26 | 20 | 10 | POM | 2.7 | 41 | D | 0.28 | A |
| 27 | — | — | POM | 2.7 | — | — | 0.67 | D |
| 28 | 1 | 0.5 | POM | 2.7 | 38 | C | 0.66 | C |

### Fabrication of Molded Bodies 29 to 34

Curable compositions were prepared using the following components, and molded bodies 29 to 34 were fabricated using stereolithography.

### Polyfunctional Radically Polymerizable Compound (A)

A-1: urethane acrylate (Shikoh UV-6630B, manufactured by Mitsubishi Chemical Corporation, ethylenically unsaturated group equivalent 1500 g/eq)
A-2: alicyclic diacrylate (Shikoh UV-6630B, manufactured by Mitsubishi Chemical Corporation, ethylenically unsaturated group equivalent 1500 g/eq)
A-3: ethoxylated bisphenol diacrylate (NK Ester ABE-300, manufactured by Shin-Nakamura Chemical Co., Ltd., ethylenically unsaturated group equivalent 466 g/eq)
A-4: urethane acrylate compound (Shikoh UV-3550AC, manufactured by Mitsubishi Chemical Corporation, ethylenically unsaturated group equivalent 7000 g/eq)
A-5: urethane acrylate (EBECRYL8210, manufactured by Daicel-Allnex Ltd., ethylenically unsaturated group equivalent 150 g/eq)

### Monofunctional Radically Polymerizable Compound (B)

B-1: N,N′-dimethylacrylamide (DMAA, KJ Chemical Corporation)
B-2: isobornyl acrylate (manufactured by Tokyo Chemical Industry Co., Ltd.)
B-3: N-acryloylmorpholine (ACMO, manufactured by KJ Chemical Corporation) Curing agent
C-1: bis(2,4,6-trimethylbenzoyl)phenylphosphine oxide (photo-radical polymerization initiator)

### Molded Body 29

The following components were blended and stirred at 75° C. for 2 hours to prepare a curable composition.

| | |
|---|---|
| A-1 | 40 parts by mass |
| A-2 | 15 parts by mass |
| A-3 | 20 parts by mass |
| B-1 | 25 parts by mass |
| C-1 | 1 part by mass |
| Particles No. 1 | 25 parts by mass |

The ethylenically unsaturated group equivalent of a mixture of A-1 to A-3 as a polyfunctional radically polymerizable compound (A) is 893 g/eq.

Using the prepared curable composition, shaping was performed using a 3D printer (DWS-020X manufactured by DWS, a stereolithography apparatus using a constrained surface method) according to slice data based on a three-dimensional shape of a rectangular parallelepiped having a size of 30 mm×30 mm×4 mm. The shaped article was produced by stacking cured layers of 30 mm×4 mm×50 μm thick to a height of 30 mm. The obtained shaped article was irradiated with ultraviolet light for 30 minutes using UV Curing Unit M (manufactured by DWS), and then subjected to heat treatment in a heating oven at 50° C. for 1 hour and further in a heating oven at 100° C. for 2 hours, thereby fabricating molded body 29 as a test piece.

### Molded Body 30

Molded body 30 was fabricated by preparing a curable composition in the same manner as molded body 29, except that the composition of the components was changed as follows.

| | |
|---|---|
| A-4 | 40 parts by mass |
| B-2 | 30 parts by mass |
| B-3 | 30 parts by mass |
| C-1 | 1 part by mass |
| Particles No. 1 | 25 parts by mass |

### Molded Body 31

Molded body 31 was fabricated by preparing a curable composition in the same manner as molded body 29, except that the composition of the components was changed as follows.

| | |
|---|---|
| A-5 | 55 parts by mass |
| B-4 | 45 parts by mass |
| C-1 | 1 part by mass |
| Particles No. 1 | 25 parts by mass |

### Molded Body 32

Molded body 32 was fabricated by preparing a curable composition by the same method as molded body 29, except that particles No. 1 were not added.

### Molded Bodies 33 and 34

Molded bodies 33 and 34 were each fabricated by preparing a curable composition by the same method as molded body 29, except that particles No. 1 were changed to particles No. 17 or 18.

### Evaluation of Molded Bodies 29 to 34

Molded bodies 29 to 34 obtained above were evaluated in the same manner as molded bodies 1 to 28. The results are shown in Table 4. For all the molded bodies, the Young's modulus of the matrix resin was 3.6 GPa.

TABLE 4

| | Particles | | Radically polymerizable compound | | | | | | | | |
|---|---|---|---|---|---|---|---|---|---|---|---|
| | | Amount | Polyfunctional (A) | | | Monofunctional (B) | | Evaluation | | | |
| | | added | | Content | Ethylenically | | Content | Change rate ΔP | | Specific wear rate | |
| Molded | | [parts | | [parts | unsaturated | | [parts | Measured | | Measured | |
| body | | by | | by | group equivalent | | by | value | Eval- | value | Eval- |
| No. | No. | mass] | Components | mass] | [g/eq] | Components | mass] | [%] | uation | [mm³ · N⁻¹ · km⁻¹] | uation |
| 29 | 1 | 25 | A-1 | 40 | 893 | B-1 | 25 | 4 | A | 0.12 | A |
| | | | A-2 | 15 | | | | | | | |
| | | | A-3 | 20 | | | | | | | |
| 30 | 1 | 25 | A-4 | 40 | 7000 | B-2 | 30 | 8 | A | 0.16 | A |
| | | | | | | B-3 | 30 | | | | |
| 31 | 1 | 25 | A-5 | 55 | 150 | B-4 | 45 | 17 | B | 0.27 | A |
| 32 | — | — | A-1 | 40 | 893 | B-1 | 25 | — | — | Measurement | D |
| | | | A-2 | 15 | | | | | | limit | |
| | | | A-3 | 20 | | | | | | | |
| 33 | 17 | 25 | A-1 | 40 | 893 | B-1 | 25 | 48 | D | 0.79 | D |
| | | | A-2 | 15 | | | | | | | |
| | | | A-3 | 20 | | | | | | | |
| 34 | 18 | 25 | A-1 | 40 | 893 | B-1 | 25 | 41 | D | 0.61 | C |
| | | | A-2 | 15 | | | | | | | |
| | | | A-3 | 20 | | | | | | | |

According to the present disclosure, a technique advantageous in achieving a molded body having good mechanical properties can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A molded body comprising a matrix resin including a thermoplastic resin and a plurality of particles dispersed in the matrix resin,
wherein the particles each include a base containing, as a main component, an organosilicon compound having a siloxane bond, and protrusions supported by the base and disposed on surfaces of the particles,
the protrusions contain an inorganic substance as a main component,
the particles each include the base and fine particles, the base is in a particulate form having recesses in a surface thereof, and the fine particles each have a first portion embedded in each of the recesses of the base and a second portion forming each of the protrusions.

2. The molded body according to claim 1, wherein the fine particles contain, as a main component, any one of silica, alumina, and titania.

3. The molded body according to claim 1, wherein the plurality of particles have a particle size of 0.02 μm or more and 15.00 μm or less.

4. The molded body according to claim 1, wherein, when a particle size of the base is D_{A} and a particle size of the fine particles is D_{C}, D_{C}/D_{A} is 0.050 or more and 0.650 or less.

5. The molded body according to claim 1, wherein an embedding ratio of the fine particles defined by formula [1] below is 30% or more and 80% or less,
$$Embedding ratio ( \% ) of fine particles = ( depth of fine particles embedded in base / diameter of fine particles ) \times 100. \qquad [ 1 ]$$

6. The molded body according to claim 1, wherein the matrix resin has a Young's modulus in a range of 1.0 GPa or more and 5.0 GPa or less.

7. The molded body according to claim 1, wherein the matrix resin includes at least one of a polyvinyl resin, a polyester resin, a polyamide resin, a polyacetal resin, an acrylic resin, and an epoxy resin.

8. The molded body according to claim 1, wherein the molded body is a film.

9. The molded body according to claim 1, wherein a content of the particles is 1 part by mass or more and 50 parts by mass or less relative to 100 parts by mass of the matrix resin.

10. The molded body according to claim 1, wherein the molded body has a volume of 1 mm³ or more.

11. The molded body according to claim 1, wherein the molded body has a volume of 100 mm³ or more.

12. A curable composition comprising a plurality of particles and a curable resin material,
wherein the particles each include a base containing, as a main component, an organosilicon compound having a siloxane bond, and protrusions supported by the base and disposed on surfaces of the particles,
the protrusions contain an inorganic substance as a main component,
the particles each include the base and fine particles, the base is in a particulate form having recesses in a surface thereof, and the fine particles each have a first portion embedded in each of the recesses of the base and a second portion forming each of the protrusions.

13. The curable composition according to claim 12, wherein the fine particles contain, as a main component, any one of silica, alumina, and titania.

14. The curable composition according to claim 12, wherein the plurality of particles have a particle size of 0.02 μm or more and 15.00 μm or less.

15. The curable composition according to claim 12, wherein, when a particle size of the base is D_{A} and a particle size of the fine particles is D_{C}, D_{C}/D_{A} is 0.050 or more and 0.650 or less.

16. The curable composition according to claim 12, wherein an embedding ratio of the fine particles defined by formula [1] below is 30% or more and 80% or less,
$$Embedding ratio ( \% ) of fine particles = ( depth of fine particles embedded in base / diameter of fine particles ) \times 100. \qquad [ 1 ]$$

17. The curable composition according to claim 12, wherein a content of the particles is 1 part by mass or more and 50 parts by mass or less relative to 100 parts by mass of the curable resin material.

18. The curable composition according to claim 12, wherein the curable resin material includes a radically polymerizable compound.

19. The curable composition according to claim 12, wherein the curable resin material includes a polyfunctional radically polymerizable compound (A) and a monofunctional radically polymerizable compound (B), and
the polyfunctional radically polymerizable compound (A) has an ethylenically unsaturated group equivalent of 700 g/eq or more and 7000 g/eq or less.

20. The curable composition according to claim 19, wherein the polyfunctional radically polymerizable compound (A) is a (meth)acrylate compound or urethane (meth)acrylate compound having any one of a polyether structure, a polyester structure, and a polycarbonate structure.

21. The curable composition according to claim 12, wherein the curable resin material includes a photo-radical polymerization initiator.

22. A molded body comprising a matrix resin including a thermosetting resin and a plurality of particles dispersed in the matrix resin,
wherein the particles each include a base containing, as a main component, an organosilicon compound having a siloxane bond, and protrusions supported by the base and disposed on surfaces of the particles,
the protrusions have a Young's modulus higher than a Young's modulus of the base,
the particles each include the base and fine particles, the base is in a particulate form having recesses in a surface thereof, and the fine particles each have a first portion embedded in each of the recesses of the base and a second portion forming each of the protrusions.

23. The molded body according to claim 22, wherein the Young's modulus of the base is 0.005 GPa or more and 25.000 GPa or less, and the Young's modulus of the protrusions is 50 GPa or more and 500 GPa or less.

24. A curable composition comprising a plurality of particles and a curable resin material,
wherein the particles each include a base containing, as a main component, an organosilicon compound having a siloxane bond, and protrusions supported by the base and disposed on surfaces of the particles,
the protrusions have a Young's modulus higher than a Young's modulus of the base,
the particles each include the base and fine particles, the base is in a particulate form having recesses in a surface thereof, and the fine particles each have a first portion embedded in each of the recesses of the base and a second portion forming each of the protrusions.

25. The curable composition according to claim 24, wherein the Young's modulus of the base is 0.005 GPa or more and 25.000 GPa or less, and the Young's modulus of the protrusions is 50 GPa or more and 500 GPa or less.

26. A method for producing a molded body, the method comprising:
a step of disposing the curable composition according to claim 12 so as to have a predetermined thickness; and
a step of irradiating the curable composition having the predetermined thickness with light depending on shape data of a three-dimensional model to cure the curable composition.

27. A machine comprising the molded body according to claim 1 and a member, wherein the molded body and the member are configured to slide against each other.

28. The machine according to claim 27, wherein the particles are present on a sliding surface of the molded body against the member.

29. A machine comprising the molded body according to claim 1 as a bearing, a gear, a cam, or a roller.

30. An electrophotographic apparatus, wherein at least one of a photosensitive drum, a roller, and a belt includes the molded body according to claim 1.
